(19) United States
(12) Patent Application Publication
(10) Pub. No.: US 2020/0404054 A1
(43) Pub. Date: Dec. 24, 2020

(54) COMPUTERIZED SYSTEM, METHOD AND COMPUTER PROGRAM PRODUCT, FACILITATING REAL ESTATE TRANSACTIONS

(71) Applicant: Reali Inc., San Mateo, CA (US)

(72) Inventors: Ami Amiel Shai AVRAHAMI, Rehovot (IL); Amit HALLER, Belmont, CA (US); Stacy Kirsten HOOVER, Santa Cruz, CA (US)

(21) Appl. No.: 16/905,159

(22) Filed: Jun. 18, 2020

(30) Foreign Application Priority Data
Jun. 19, 2019 (IL) 267514

(51) Int. Cl. H04L 29/08; H04L 12/58; H04L 29/06; G06Q 50/16

(52) U.S. Cl. CPC H04L 67/1091; H04L 67/1044; H04L 67/40; H04L 65/608; G06Q 50/16; H04L 51/06

(57) ABSTRACT

A software system comprising a mobile app having a backend including a processor, whose logic supports plural functionalities used by end-users/clients of the mobile app; logic presenting, to each of a population of end users of the mobile app, a linear list of the functionalities, thereby defining an ordering of the functionalities; logic presenting an indication (aka journey status change aka journey status update), to each individual end-user, in at least near-real time, of how far along the list s/he has progressed in using the functionalities, wherein the mobile app logic allows at least one individual end user to use the functionalities repeatedly and in a sequence other than defined by the ordering, at least once the individual end-user has used all of the functionalities at least once.

### FIELD OF THIS DISCLOSURE

The present invention relates generally to software, and more particularly to mobile applications (aka mobile apps).

### BACKGROUND FOR THIS DISCLOSURE

PubNub aka “pubnub” herein is intended to include PubNub.com's realtime publish/subscribe messaging API, built on the pubnub global data stream network which comprises a replicated network of data centers on several networks and provides realtime infrastructure-as-a-service.

PubNub technology utilizes a Publish/Subscribe model for realtime data streaming and device signaling and supports streaming protocol capabilities such as those of the following streaming protocols: WebSockets, Socket.IO, SignalR, WebRTC Data Channel PubNub provides SDKs for various programming languages and environments such as JavaScript, iOS, and Android, as well as JavaScript frameworks such as AngularJS, Ember.js, and Backbone.js. PubNub provides client libraries for board platforms such as Raspberry Pi, Arduino, Tex. instruments, and Microchip.

Pubnub provides, inter alia:

Functions: a set of customizable microservices that give developers a simple way to add code and deploy features for realtime apps
Publish/Subscribe Messaging: provides realtime data streaming and device signaling, and includes built in AES encryption and optional TLS/SSL encryption. The atomic components that make up a data stream are API Keys, Messages, and Channels. This feature handles channels in a lightweight manner, allowing software developers to create an unlimited number of channels for any set of API keys without first declaring the channel.
Online Presence Detection: provides tracking of online and offline status of users and devices in realtime. Presence events are triggered when a connected device subscribes or unsubscribes from a channel, or times out. The Presence API also includes a “state” feature allowing for the persistent tracking of any name/value pair a software developer specifies, such as a “typing” event indicator in a basic chat application.
Access Management: provides fine grain read and write access control on a per user, device, or channel basis. This adds an extra layer of security and enables the syndication of streams by providing authorization to individual users, as well as grant/revoke permissions at the channel or key level.
Data Stream Controller: multiplexes individual data streams as a single persistent connection, and centralizes control of the creation and modification of groups of data channels at the server level.
Storage & Playback: stores messages as they are published to a data channel, and retrieves them from high-availability storage clusters at a later time. Data streams can also be replayed as they were broadcast in realtime.
Mobile Push Notifications bridges native Pub/Sub Messaging API publishing with third-party push notification services including Google Android GCM, Apple iOS APNS, and Microsoft Windows Phone MSNP. The developing, configuring, and maintaining of server side components for third-party providers is provided by the PubNub API.
ChatEngine: open source, object oriented, event emitter based framework for building chat applications in JavaScript. provides chat application components such as typing indicators, online presence monitoring, and message history. built with connectors to PubNub's APIs, e.g. Publish/Subscribe Messaging and Storage & Playback.

It is appreciated that pubnub technology is only one possible alternative implementation; alternative p2p services or any data stream network and/or real-time infrastructure-as-a-service may be employed such as but not limited to other publish/subscribe alternatives e.g. Pusher or Socket.io or a service based on a real-time communication service for connecting online devices, e.g. with a Publish-Subscribe messaging API, such as for example Emitter.io.

Jira is referred to herein as an example of a software development tool for bug tracking and/or project management.

Zeplin is referred to herein as an example of software which facilitates moving files back and forth between designers and engineers.

Echo is referred to herein as an example of web application framework software. Echo is an example of software that supports writing applications in either server-side Java or client-side JavaScript.

Deep linking may use a hyperlink or URL that links to a typically searchable or indexed item of web content on a website rather than, say, to the website's home page. While the Hypertext Transfer Protocol (HTTP), does not distinguish between “deep” and other links, In mobile apps, deep linking typically involves using a uniform resource identifier (URI) that links to a specific location within a mobile app.

A splash screen is intended to include any graphical control element which may comprise a window containing all or any subset of an image, a logo, or a current version of software. A splash screen may appear while a program is launching.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide a computerized system and/or method and/or compute program product, facilitating transactions, such as but not limited to real estate transactions, between end-users.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented as appropriate.

It is appreciated that any reference herein to, or recitation of, an operation being performed is, e.g. if the operation is performed at least partly in software, intended to include both an embodiment Where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform the entire operation, and, instead, the remote processor P itself may receive output/s of portion's of the operation from yet another processor/s P′, may be deployed off-shore relative to P, or “on a cloud”, and so forth.

The present invention typically includes at least the following embodiments:

Embodiment 1. A software system comprising all or any subset of: a mobile app typically having a backend including a processor, whose logic supports plural functionalities typically used by end-users/clients of the mobile app; logic presenting, to each of a population of end users of the mobile app, a linear list of the functionalities, thereby defining an ordering of the functionalities; logic presenting an indication (aka journey status change aka journey status update), e.g. to each individual end-user, typically in at least near-real time, of how far along the list s/he has progressed in using the functionalities, wherein typically the mobile app logic allows at least one individual end user to use the functionalities repeatedly and/or in a sequence other than defined by the ordering, at least once, or after, the individual end-user has used all of the functionalities at least once.

Embodiment 2. A system according to any of the preceding embodiments wherein the backend provides at least one p2p (peer to peer) notification, including a journey status change of an end-user, to a p2p processor aka p2p subsystem aka p2p logic which gets messages indicating journey status changes, and stores them.

Embodiment 3. A system according to any of the preceding embodiments wherein the p2p subsystem comprises a pubnub server which gets pubnub messages indicating journey status changes, and stores them.

Embodiment 4. A system according to any of the preceding embodiments wherein the indication comprises a graphic indication e.g. checkmark associated with each of the functionalities on the linear list, which the individual end-user has already used and wherein no graphic indication is associated with functionalities on the linear list, which the individual end-user has not yet used.

Embodiment 5. A system according to any of the preceding embodiments wherein the p2p notification includes a journey data flat map storing a user journey steps and/or tasks, and wherein at least one client uses a journey payload to update at least one journey task on each p2p notification.

Embodiment 6. A system according to any of the preceding embodiments wherein when a client receives a journey status update, the update may be represented in a flat (not relational) map which includes a representation of the user journey including, in a single list, steps and/or tasks included in the journey, and wherein the update also includes a step/task key and/or a display name

Embodiment 7. A system according to any of the preceding embodiments wherein a single p2p channel and infrastructure is used to pass, as p2p messages, chat messages including text for the end-user to view; and journey status update.

Embodiment 8. A system according to any of the preceding embodiments wherein at least one chat message includes metadata which includes an identification of the chat message's sender and/or a media download key and/or a timestamp.

Embodiment 9. A system according to any of the preceding embodiments wherein the p2p processor uses sockets rather than API polling to receive a real time indication of journey status changes.

Embodiment 10. A system according to any of the preceding embodiments wherein the metadata is stored in the p2p side, in association with messages history.

Embodiment 11. A system according to any of the preceding embodiments wherein the metadata is stored locally, on the end users smartphone's local storage.

Embodiment 12. A system according to any of the preceding embodiments wherein at least one mobile client saves at least some properties in order to subsequently display the properties later including retrieving the properties from the local storage rather than requesting the properties from the p2p service.

Embodiment 13. A system according to any of the preceding embodiments and also comprising at least one ‘get history’ API via which chat and status update messages stored by the p2p subsystem are retrieved.

Embodiment 14. A system according to any of the preceding embodiments wherein a server, upon identifying a journey status change relating to a given end-user, sends a message to a dedicated p2p channel extending to that end-user's client and wherein the end-user's client asks the history of the dedicated channel at a subsequent time, and if the client identifies a status change type message, the client makes a journey status change.

Embodiment 15. A system according to any of the preceding embodiments wherein the client includes logic which prioritizes asking the history during client-idle time over asking the history at a time t which is not client-idle time.

Embodiment 16. A system according to any of the preceding embodiments wherein the client includes logic which prioritizes asking the history during channel-idle time over asking the history at a time t which is not channel-idle time.

Embodiment 17. A system according to any of the preceding embodiments e.g. 15 or 16 wherein the client includes logic which always asks the history during idle time.

Embodiment 18. A method for facilitating use of a mobile app by end-users, the method comprising:

providing a mobile app having a backend including a processor, whose logic supports plural functionalities used by end-users/clients of the mobile app;

presenting, to each of a population of end users of the mobile app, a linear list of the functionalities, thereby defining an ordering of the functionalities;

presenting an indication (aka journey status change aka journey status update), to each individual end-user, in at least near-real time, of how far along the list s/he has progressed in using the functionalities,

wherein the mobile app logic allows at least one individual end user to use the functionalities repeatedly and in a sequence other than defined by the ordering, at least once the individual end-user has used all of the functionalities at least once.

Embodiment 19. A method according to any of the preceding embodiments wherein the end-users include buyer end-users and seller end-users and the mobile app supports creation and managing by an individual buyer end-user, of plural draft offers to plural seller end-users wherein the managing comprises defining branching logic for sending the draft offers to the seller end-users thereby to enable a buyer interested in more than one property offered by more than one respective seller end-user, to create a main offer and at least one additional draft offer/s and to define, even before the main offer has been accepted or refused, an actionable backup plan defining, via the branching logic, how the additional draft offers are to be engaged if the main offer is refused.

Embodiment 20. A method according to any of the preceding embodiments wherein the end-users include buyer end-users and seller end-users and the mobile app supports creation and managing by an individual buyer end-user, of at least one draft offer to at least one respective seller end-user and wherein the managing includes modifying at least one parameter of a draft offer, responsive to a counter-offer proposed by the seller end-user.

Embodiment 21. A method according to any of the preceding embodiments wherein the end-users include buyer end-users and seller end-users and the mobile app supports creation and managing by an individual buyer end-user, of at least one offer to at least one respective seller end-user and wherein a virtual assistant is used to generate the offer.

Embodiment 22. A method according to any of the preceding embodiments wherein the offer includes a proposed buyer-seller transaction whose value is generated automatically, thereby to allow buyer end-users to benefit from automatically generated real estate value predictions.

Embodiment 23. A method according to any of the preceding embodiments wherein at least one market report is retrieved during creation of at least one offer.

Embodiment 24. A method according to any of the preceding embodiments wherein creation of at least one offer is expedited by holding a chat between the buyer end-user of the app and an expert end-user of the app.

Embodiment 25. A computer program product, comprising a non-transitory tangible computer readable medium having computer readable program code embodied therein, the computer readable program code adapted to be executed to implement a method for facilitating use of a mobile app by end-users, the method comprising:

providing a mobile app having a backend including a processor, whose logic supports plural functionalities used by end-users/clients of the mobile app;

presenting, to each of a population of end users of the mobile app, a linear list of the functionalities, thereby defining an ordering of the functionalities;

presenting an indication (aka journey status change aka journey status update), to each individual end-user, in at least near-real time, of how far along the list s/he has progressed in using the functionalities,

wherein the mobile app logic allows at least one individual end user to use the functionalities repeatedly and in a sequence other than defined by the ordering, at least once the individual end-user has used all of the functionalities at least once.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor's, display and input means may be used to process, display e.g. on a computer screen or other computer output device, store, and accept information such as information used by or generated by any of the methods and apparatus shown and described herein; the above processor's, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMS, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g. BLE) or wired (e.g. USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processorls or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may for example comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processes or controller/s are not specifically illustrated for simplicity. The controller or processor may be implemented in hardware, e.g., using one or more Application-Specific Integrated. Circuits (ASICs) or Field-Programmable Gate Arrays (FPGAs) or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation dearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (h) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “ui” as used herein includes also the underlying logic which controls the data presented to the user e.g. by the system display and receives and processes and/or provides to other modules herein, data entered by a user e.g. using her or his workstation/device.

### BRIEF DESCRIPTION OF FIGS. AND TABLES

Example embodiments are illustrated in the various drawings and tables; arrows between modules may be implemented as APIs, and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML.

Specifically:

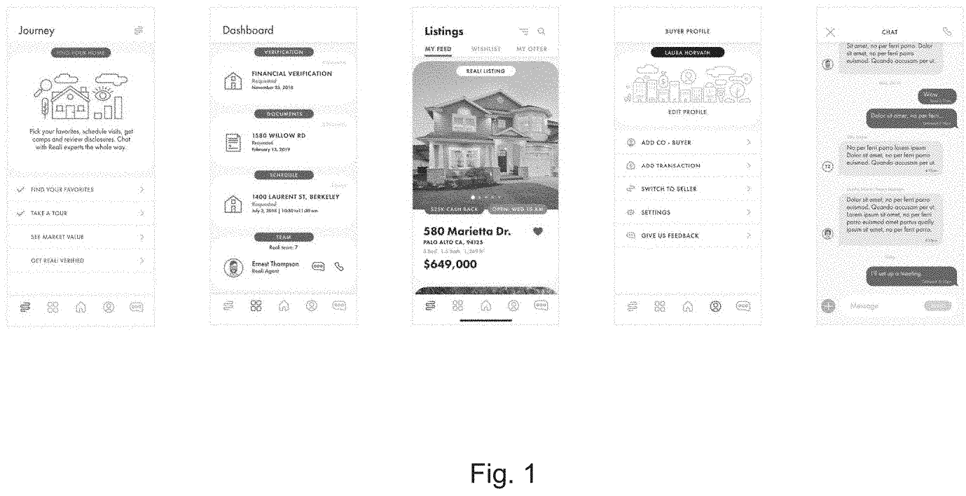

FIG. 1 illustrates example tab navigation screens e.g. for a mobile app, including a screen for journey tab navigation, a screen for dashboard tab navigation, a screen for listings tab navigation, a screen for buyer profile tab navigation, and a screen for chat tab navigation, all or any subset of which may be provided (respectively including all illustrated elements or any subset thereof).

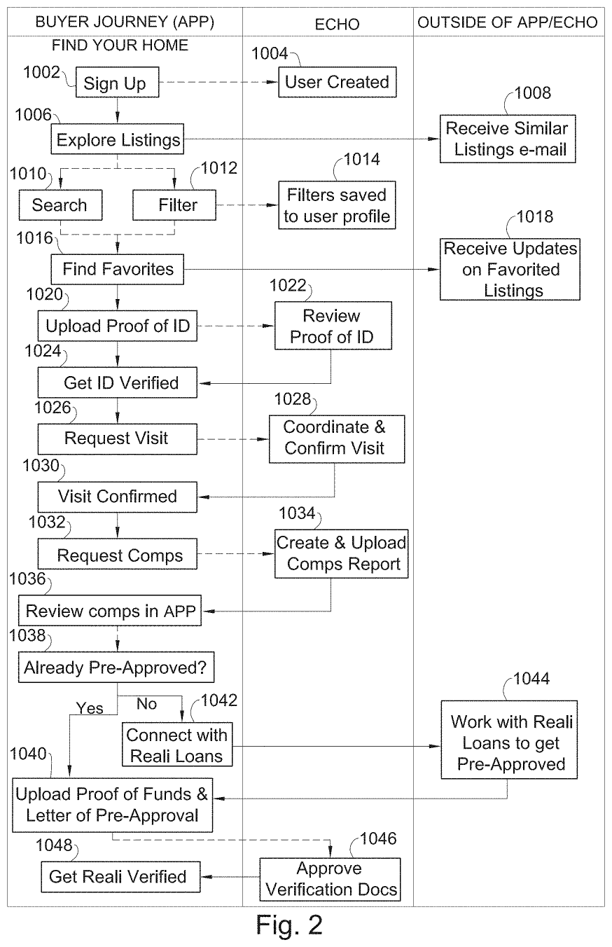

FIGS. 2-4 are simplified swim-lane diagrams useful in understanding certain exemplary embodiments.

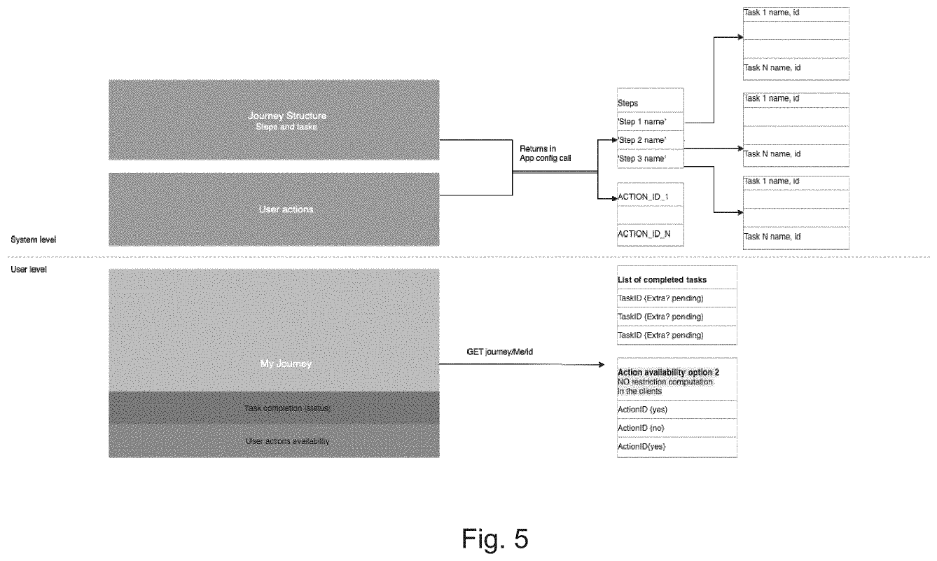

FIGS. 5-7 are simplified diagrams and flows useful in understanding certain exemplary embodiments.

Tables I-xv are described herein merely by way of example; inter alia, it is appreciated that in each table herein, all or any subset of the rows, columns and cells shown, may actually be provided.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown. Tables herein may include all or any subset of the fields and/or records and/or cells and/or rows and/or columns described.

In the swim-lane diagrams, it is appreciated that any order of the operations shown may be employed rather than the order shown, however preferably, the order is such as to allow utilization of results of certain operations by other operations by performing the former before the latter, as shown in the diagram.

In the flow diagrams, the method typically comprises all or any subset of the illustrated operations, suitably ordered e.g. as shown:

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology) or any combination thereof.

Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case all or any subset of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor or as a virtual instance (locally configured or in a cloud based computing environment), configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

FIG. 1 illustrates tab navigation screens e.g. for a mobile app serving as a software platform for real estate transaction partners, FIG. 1 includes a first screen for journey tab navigation, a second screen for dashboard tab navigation, a third screen for listings tab navigation, a fourth screen for buyer profile tab navigation, and a fifth screen for chat tab navigation, all or any subset of which may be provided with supporting logic to enable each page to be displayed and to enable user input entered via that page, to be processed including transitions to other pages. For example, chat icons may be provided in any suitable location on the various display screens e.g. on the first, journey tab navigation screen; clicking on the chat icon then transits the end-user to chat functionality.

Typically, the first display screen displays checkmarks indicating to the end-user which mobile app functionalities s/he has succeeded in activating at least once; for example, in the illustrated embodiment, the end-user has completed the first two functionalities or menu items (find favorites and take tour) but has not yet completed the following 2 mobile app functionalities namely seeing market value of at least one home, and getting verified, in terms of identity and/or financially. Typically, the first display screen includes only functionality pertaining to the home finding stage of an end-user's journey, and typically does not include functionalities pertaining to the offer-making stage, or closing stage.

The second, Dashboard screen may serve as a springboard into a journey through the app, particularly for experienced end-users, and typically helps users find their verification status, documents, visits and team members (end-users of the system herein, such as lead a expert, local expert, transaction expert, back office expert, mortgage expert, which are associated with a given buyer). The dashboard screen menu includes all or any subset of the following menu items: Verification, Documents, Schedule, Team, and Offer (not shown). The “documents” menu item may, if selected, display to a user statuses of various property reports for various respective properties. The status may for example be “requested”, “in progress”, “incomplete”, “complete” etc. Each such status may include a link leading the end user to a pdf property report document. “Schedule” may, if selected, display to a user statuses, which may be arranged in date order, of various appointments to visit properties; each such status typically includes the property's address, date and time of appointment for the end-user to see this property, and status of that appointment e.g. complete, incomplete, confirmed, pending, cancelled, rescheduled, requested. The journey tab navigation mobile app screen typically includes all or any subset of the following menu items: Find favorites (aka wishlist), take tour (which may be “scheduled” as described herein), see market value, or get verified. Verification may, for example, comprise uploading, by an end-user of suitable documents such as pre-approval and proof of funds letters for financial verification by system logic and/or ID documents of buyer and/or of signatories on a contract for ID verification by system logic.

‘Verification” may include an end-user uploading scanned documents such as a Letter of Pre-Approval from a bank stating how much the end-user can afford and Proof of Funds.

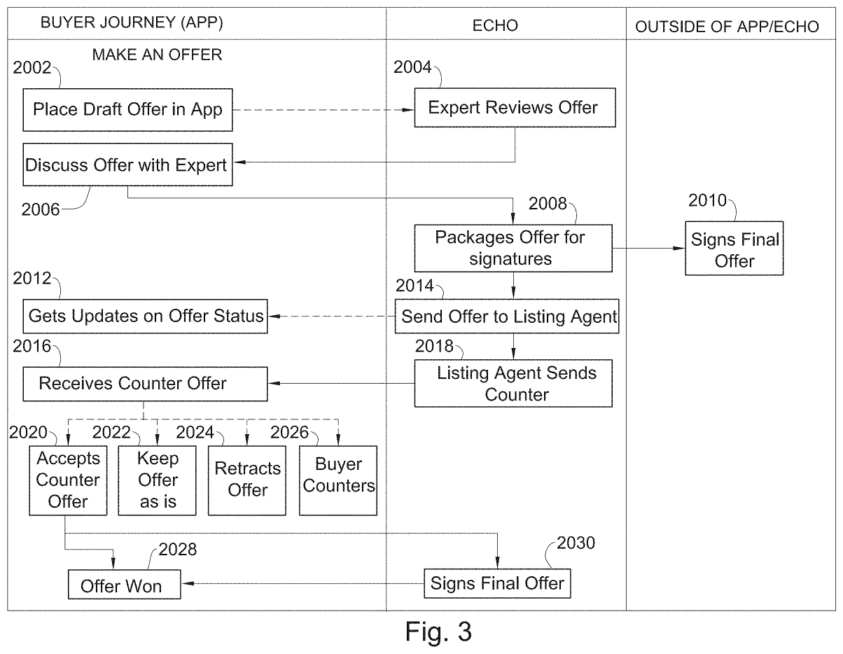

FIGS. 2 and 3 are simplified swim-lane diagrams of operations, all or any subset of which may be performed, in any suitable order e.g. as shown, by an app (first column), by a backend software subsystem such as Echo, or any other workflow UI software such as, say, Salesforce.

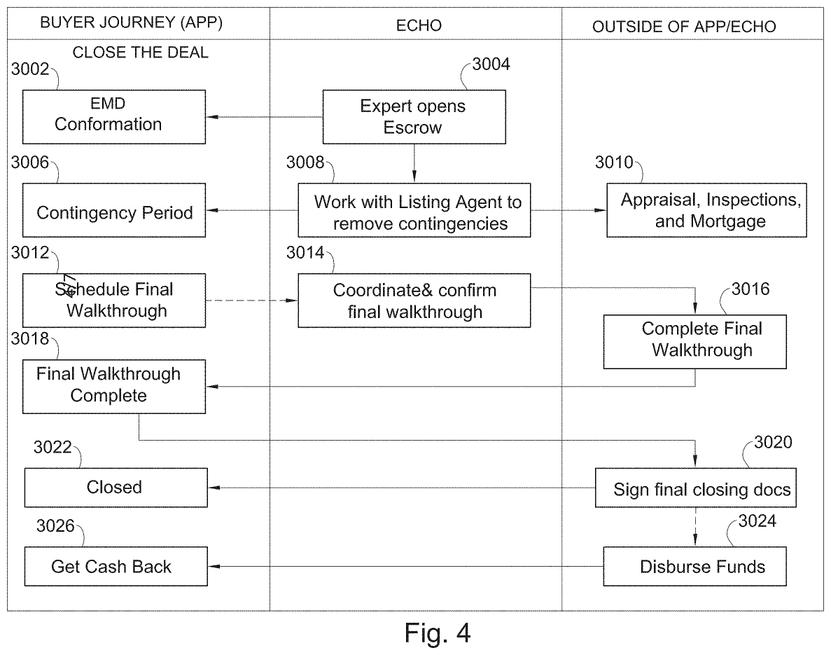

Second column in FIGS. 2 to 3, and third column in FIGS. 2 to 3 illustrate operations performed outside of the app and outside of Echo. FIG. 2 supports an end-user's attempts to find a home. FIG. 3 supports an end-user's attempts to make an offer on a home s/he has found. According to certain embodiments, a given end-user can only place one offer at a time. FIG. 4 supports an end-user's attempts to close a deal to purchase the home s/he has found. “Reali” is used to refer to a computerized organization associated with the system of the present invention or to the system itself, or components therewithin such as the mobile app described herein.

A layman's description of an example user experience, all or any subset of which may be generated by the methods of FIGS. 2-4 is as follows where ‘you” refers to the end-user, and “we” refers to the computerized organization associated with the system of the present invention or to the system itself:

### “FIND YOUR HOME”

Pick your favorites, schedule visits, get comps and review disclosures. Chat with Reali experts the whole way.
As you look through the listings, you can pick your favorites, schedule visits, and even make an offer.
Before visiting a home with one of our experts, we ask that you verify your identity. This helps us check that you're really you, keep our experts safe, fight fraud, and more.
Found your favorites? Schedule a visit and check it out in person. Make notes, take photos, and share with others.
Reali Experts will do a comparative market analysis (Comps) to help you understand the value of the home. We'll pull data on all things that might affect the property's value like the supply and demand, the neighborhood, proximity to schools, and entertainment.
We will check your ID, (So we've got the right person) and confirm how much you're qualified for (so we can get you in the right home).

### MAKE AN OFFER

Together we will process, submit, and win your home for the best price. Found your dream home? It's offer time. select the home you want to focus on and place your offer.
Ready to sign! We've reviewed your offer, it just needs your signature. Once signed, we will package your offer, pre-approval documents, and any additional documents and send them to the Listing Agent. We will let you know once the Listing Agent has confirmed receipt of your offer.
The seller has submitted a counter offer. You now have to review it and: Accept it, submit a counter offer, or reject it.
Your offer has been accepted! Time to move into escrow.

### CLOSE THE DEAL

Submit your Earnest. Money Deposit (EMD) and you're in escrow! Your EMD is a good faith deposit and will be applied to closing costs.
If you had any contingencies in your offer, the clock is ticking. Now is the time to secure your mortgage and work with your Expert to get inspections completed so contingencies can be removed.
Complete your final walkthrough within 5 days of closing (unless you waived it). This gives you a last chance to look over the house and make sure repairs were made and there is no new damage.
Closing is the final step. Both parties sign the final paperwork, and the buyer becomes the legal owner of the home. Once the home sale is recorded, your Expert will meet you and give you the keys to your new home.
Since Reali represented you in your transaction, you get that cash back. You should receive your cash back within 10 days of closing.”

FIG. 5 shows the system- (above dotted line) and user- (below) levels of a backend subsystem e.g. server logic which typically defines and manages journey structure including, typically, steps and tasks. The backend subsystem may also define and maintain user action items used on a user's journey level to indicate user action restrictions e.g. according to journey state. A user's “journey status” may include her or his completed tasks and/or may include the user's current action restrictions. Users may be restricted from performing actions, depending on their Journey status.

Any suitable solution may be implemented, for client awareness for Journey status changes. Given a dedicated API and defined structure for receiving each user's Journey status (e.g. completeness & actions restrictions), a user request for current status may occur anywhere in the flow, e.g. when the app is in the foreground, a user may get a chat notification indicating the change, and, at this point, the client corresponding to that user, may get the Journey status.

The flow is typically designed to avoid overloading the server with unnecessary status requests that may cause redundant DB access. For example, given a user with notifications turned off and an app in the background, while coming to the foreground, a request for status change may be redundant, resulting in redundant server work.

Any suitable protocol may be employed by a client requesting its end-users Journey status from the server.

p2p functionality e.g. Pubnub may be employed to yield a client-server mechanism operative to sustain changes in the journey structure, action restrictions, and action definitions. The server, upon identifying journey status change per user which may be triggered by any suitable trigger/s e.g. an Echo or an app action, may then send a message (e.g. dedicated channel or actual chat text messages to be presented to an end-user, with associated meta data) to a channel. The client may ask the history of this channel (typically, whenever it likes, e.g. during client- or channel- idle time), and upon identifying a status change type message, a journey status change may be made, typically each time the client identifies a status change type message. Statuses indications, e.g. indicating to a client that a task has been completed, yield an advantageous near real time responsiveness.

The following entities which may be defined (typically depending on the action/task) e.g. in the back end aka main server and/or on the mobile client, may include all or any subset of the following content respectively:

Journey Map: list of steps, Id, Name, Type, Steps

Step: Name, list of tasks

Task: Task_Key, Name, Status

User_Action: Action Key

Re Mobile clients and echo clients, the steps and tasks status can be triggered either by Echo or an app action.

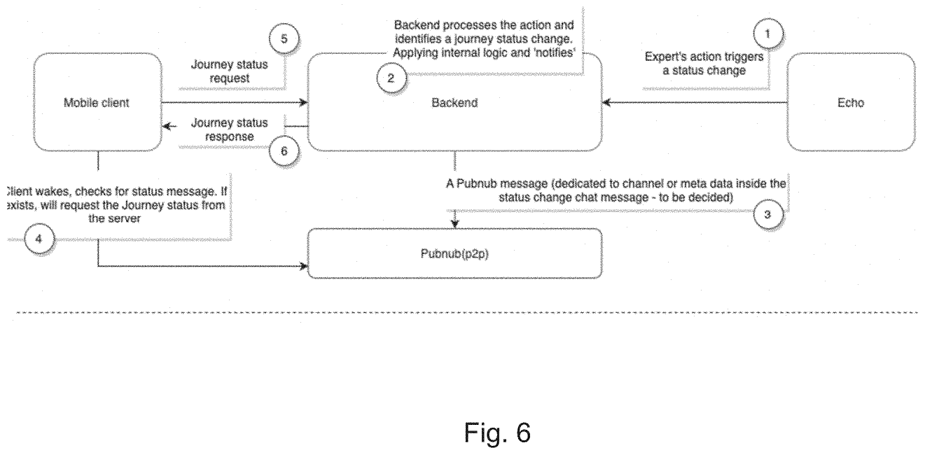

FIGS. 5-6 describe how, according to an embodiment of the invention, to implement a “checkmark feature” which provides journey status updates and typically includes Logic presenting, to each of a population of end users of the mobile app, a linear list of the functionalities, thereby defining an ordering of the functionalities; and/or Logic presenting an indication (aka journey status change), to each individual end-user, in at least near-real time, of how far along the list s/he has progressed in using the functionalities. Typically, the mobile app logic allows at least one individual end user to use the functionalities repeatedly and in a sequence other than defined by the ordering, at least once the individual end-user has used all of the functionalities at least once.

Typically, the p2p notification contains the journey data (flat map) which is reliable in that the success rate of receiving p2p notifications is acceptably high, given demands of the situation. The client may use a journey payload (e.g. user journey representation in a JSON form) to update the journey tasks on each p2p notification. The flat map typically includes a representation of the user journey (e.g. steps and/or tasks) e.g. in a single list which typically contains a step/task key and/or a display name. When a client receives a journey status update, the update may be represented in a flat map (not relational).

In FIG. 6, the “expert” typically comprises a system-licensed human agent typically working in suitable back office software, such as Echo.

In step 1, any suitable action's of an expert may trigger a change from one status to another. Typically, the expert processes and confirms a request (e.g. request for a visit, or a verification) that changes the status of that request. For example, perhaps a user submits a request for a visit (status requested), then an expert begins confirming availability of appointment (status pending), then finally confirms visit (status confirmed). The expert, processing and moving a request through the process, typically automatically triggers respective status updates, as the backend (e.g. in step 2)“processes” the expert's action to identify a journey status change.

Typically, when there is a first request for a specific type request (comps, visit, offer, etc.) the action of changing the status from pending or requested, to confirmed or complete, marks a journey step as complete. For example, when a user requests a visit for the first time and an expert confirms the visit, the journey step ‘Schedule a Visit’ may be marked as complete e.g. with a ticked mark. Any additional requests of the same type typically do not affect the journey.

In operation 3, ‘Status change chat message’ typically comprises a p2p (peer to peer) message. Typically, the same p2p channel and infrastructure is used to pass both chat messages and ‘status update’ messages.

A chat message's metadata may include all or any subset of sender, media download key, timestamp and/or other properties unrelated to the text the consumer views. Metadata is typically stored in the p2p side, typically along with messages history and/or on the device (e.g. local storage). Typically, the mobile client saves at least some properties in order to display them later from the local storage, without having to request from the p2p service.

In operation 4—the journey status may be requested from the pubnub (or p2p) server or from the backend server. This request may include a unique client ID used by the server to uniquely distinguish one end-user from another. Typically, each user, or Journey, has a unique ID. Upon launch, the client checks with the backend to determine the status for that journey.

In operation 6—the status response may indicate that end-user x has reached a given point within the linear list, e.g. has used the first “find your favorites” functionality in the linear list, and the “take a tour” functionality, but has yet to use the subsequent “see market value” and “get system verified” functionalities in the list. The backend may respond with the journey status in two ways: which sub-steps has the user completed (‘Find Favorites’, ‘Take a Tour’, etc. . . . ) and in which overall step the user currently is engaged (‘Step 1, Find Home’, ‘Step 2, Make an Offer’, etc.)

The pubnub (or other p2p functionality) block typically gets pubnub messages indicating journey status changes, and stores them. The p2p block—e.g. Pubnub—typically stores both chat and status update messages and typically stores every such message. Messages stored by the p2p e.g. pubnub block may be retrieved e.g. via ‘get history’ APIs.

The backend block is typically configured to serve two clients, Mobile and Echo.

Typically, usage of the p2p service ensures that the user's app gets journey updates aka status change indications in near real time, without server overloading with unnecessary status requests that would cause redundant DB access. For example, typically, upon a change in the user journey status, the p2p service may use sockets (rather than API polling) to receive a ‘real time’ indication. By saving an extra backend API call, the update is pushed’ to the client. Thus, even when the app is open and in the foreground, once a trigger occurs on the backend side, data is updated immediately on the client. Typically, API calls for the server are saved in order to retrieve data; thus redundant data access that would result, in most cases, in a ‘no change’ result, is saved. In contrast, if the client were configured to ask the server on curtain flows (e.g. when the journey view appears to the user), this would result in much redundant DB access for a response that contains no change.

According to certain embodiments, users are not required to register merely in order to explore the app which can be done without the user creating an account. Typically, only once an end-user wants to do something that generates data which is stored in the system DB such as, say, all or any subset of favorite a listing, scheduling a visit, chatting with an expert, the end-user is prompted to register, aka “force sign up”.

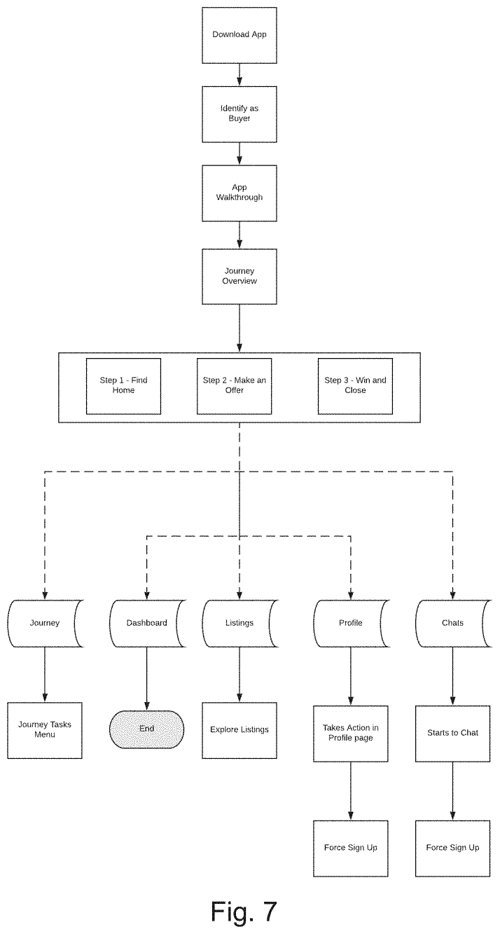

FIG. 7 illustrates a flow of functionalities that an end-user may have access to without registering. For example, “Explore listings” refers to a split after onboarding where a user can enter the app without registering; typically such an end-user is taken to the homes tab where s/he can search and filter for listings. In FIG. 8, curved boxes indicate a main navigation tab as opposed to actions which may be shown in rectangles; dotted lines indicate a choice the user makes rather than (e.g. as shown in solid line) the next logical step in the app. For example, once an end-user identifies a buyer, her or his only option is to advance through onboarding, whereas once the end-user reaches the journey overview screen, s/he can choose which tab to explore. It is appreciated that the illustrated flow is merely an example and many variations are possible e.g. in a “profile page”, there may be only one action—tapping “sign in”—or there may be plural possible actions.

According to certain embodiments, each end-user identifies as a buyer or a seller, depending on whether s/he is interested in buying or selling a home. in the former/latter case, the user is typically shown a buyer's/seller's journey respectively.

In FIG. 8, the term “App walkthrough” refers to onboarding, typically including presentation of a few initial screens that describe the app and service.

“Step1” may for example include all or any subset of the operations shown in FIG. 2. “Step2” may for example include all or any subset of the operations shown in FIG. 3. “Step3” may for example include all or any subset. of the operations shown in FIG. 4.

### Dashboard

The dashboard, for which an example screen display appears in FIG. 1, is now described in detail, according to an example embodiment. Regarding tables herein, it is appreciated that any subset of the rows, columns and cells herein, may be provided in alternative embodiments. The dashboard is a virtual location within the app where end-users may go to find all documents, verification status, visits and team members. Over time, more functionality may be added to the dashboard, creating a sort of springboard into the journey for more experienced users or people further along in the journey.
User Stories for the dashboard are described in the following table, Table I.

TABLE I

| # | Title | Description | User Story |
|---|---|---|---|
| 1 | Launch of | Ability to | GIVEN that I am a user |
| | Dashboard Tab | access | WHEN I tap on the Dashboard Icon on the tab bar |
| | | dashboard | THEN I will be land on the Dashboard main screen |
| | | from main tab | |
| | | bar | |
| 2 | Dashboard tab | As a user, I | GIVEN that I am an anonymous user |
| | restrictions | need to be | OR I am signed in user who does not have any tasks, |
| | | informed of | documents, visits or events |
| | | what content I | WHEN I tap on the Dashboard Icon on the NavBar |
| | | can find on the | THEN I will land on the Dashboard Empty State main |
| | | documents tab | screen |
| 3 | Dashboard Sections | As a User, I | GIVEN that I am a signed in and registered user |
| | Overview | want to be able | WHEN I land on the Dashboard tab |
| | | to see my | AND I have requested visits, uploaded documents or |
| | | documents, | events scheduled |
| | | events, visits, | THEN I will see the screen is ordered into the |
| | | etc. organized | following section cards |
| | | in a clear and | Verification |
| | | easy to | Documents |
| | | navigate way | Visits |
| | | | Team |
| 4 | Verification Card | Ability to see | GIVEN I am a user and I have not started |
| | | most recent | the identity OR financial verification |
| | | activity for | WHEN I tap the ‘Verification’ card on the main |
| | | verification | dashboard view |
| | | | THEN I should see the ‘Financial Verification’ item |
| | | | with status not started |
| | | | AND I should be able to explore the verification flow |
| | | | GIVEN I am a user and I have submitted |
| | | | the identity verification |
| | | | WHEN I tap the ‘Verification’ card on the main |
| | | | dashboard view |
| | | | THEN I should see the Identity Verification |
| | | | with my status |
| | | | AND I should see the ‘Financial Verification’ item with |
| | | | status not started |
| 5 | Verification Card | Ability to | GIVEN I am a user |
| | | quickly get a | WHEN I am on the main dashboard screen |
| | | snapshot of | THEN I should see the verification type with status and |
| | | recent activity | the date the status was last changed for the most recent |
| | | related to | activity |
| | | verification | AND I should see how many documents related to |
| | | | verification I have associated with my journey |
| 6 | Documents Card | Ability to see | GIVEN I am a user |
| | | most recent | WHEN I have documents associated with my Journey |
| | | activity for | THEN I should see the document title, current status, |
| | | documents | and date of most recent status change for the most |
| | | | recent activity |
| | | | AND I should see how many documents overall are |
| | | | associated with my Journey |
| 7 | Schedule Card | Ability to see | GIVEN it am a user |
| | | most recent | WHEN I have appointments associated with my |
| | | visits activity | Journey |
| | | | THEN I should see the visit title, current status, |
| | | | and date |
| | | | of visit for most recent activity |
| | | | AND I should see how many appointments overall are |
| | | | associated with my Journey |
| 8 | Team Card | Ability to see | GIVEN I am a user |
| | | Team | WHEN I have team members associated with my |
| | | members | Journey |
| | | associated | THEN I should see my Account Managers name |
| | | with my Journey | AND I should be able to chat or call him/her |

Dashboard_schedule menu item: example Requirements, all or any subset of which may be applicable in a given embodiment, are described in the following table,

TABLE ii

| # | Title | Description | User Story |
|---|---|---|---|
| 1 | Schedule | Ability to | GIVEN I am a user |
| | Overview | see all past | WHEN I tap the ‘Schedule’ card on the main dashboard view |
| | | and | THEN I should see the ‘Schedule’ screen |
| | | upcoming | AND I should see the current month view |
| | | visits with | |
| | | status | |
| 2 | Schedule | Empty State | GIVEN I am a user |
| | Overview | | WHEN I tap the ‘Schedule’ card on the main dashboard view |
| | | | AND I have no scheduled visits for the month in view |
| | | | THEN I should see an empty state |
| 3 | Requested or | Ability to | GIVEN I am a user |
| | Pending or | see | WHEN I tap an appointment with the status requested OR |
| | Rescheduled | appointment | pending OR rescheduled |
| | Appointment | details and | THEN I should see details about my visit |
| | | cancel or | AND have the ability to cancel or reschedule |
| | | reschedule | |
| | | appointment | |
| 4 | Confirmed | Ability to | GIVEN I am a user |
| | Appointment | see details | WHEN I tap an appointment with the status confirmed |
| | | about a | THEN I should see details about my visit |
| | | confirmed | AND have the ability to cancel or reschedule |
| | | appointment | |
| | | and cancel | |
| | | or | |
| | | reschedule | |
| 5 | Completed | Ability to | GIVEN I am a user |
| | Appointment | see (and | WHEN I tap an appointment with the status complete |
| | | eventually | THEN I should see details about my visit |
| | | rate) a | AND have the ability to schedule another appointment as long |
| | | previous | as the listing has status active |
| | | visit | |
| 6 | Incomplete | Ability to | GIVEN I am a user |
| | Appointment | schedule | WHEN I tap an appointment with the status incomplete |
| | | another visit | THEN I should see details about my visit |
| | | for an | AND have the ability to schedule another appointment as long |
| | | incomplete | as the listing has status active |
| | | appointment | |
| 7 | Declined | Ability to | GIVEN I am a user |
| | Appointment | schedule | WHEN I tap an appointment with the status declined |
| | | another visit | THEN I should see details about my visit |
| | | for an | AND have the ability to schedule another appointment as long |
| | | declined | as the listing has status active |
| | | appointment | |
| 8 | Quick | Ability to | GIVEN I am a user |
| | Cancel a | quickly | WHEN I swipe left on an appointment card with a |
| | Visit | cancel a | status requested OR pending OR rescheduled |
| | | visit from | OR confirmed |
| | | the calendar | THEN I will see a delete icon |
| | | view | AND if I tap the delete icon, I will be able to quickly cancel |
| | | | the appointment |

Dashboard_verification: status of verifications (financial and identity) may be provided, as well as document level status updates. Requirements, all or any subset of which may be applicable in a given embodiment, are described in the following table, Table

TABLE iii

| # | Title | Description | User Story |
|---|---|---|---|
| 1 | Verification | Ability to see | GIVEN I am a user |
| | Overview | types of | WHEN I tap the ‘Verification’ card on the main |
| | | verification | dashboard view |
| | | and status | THEN I should see the ‘Verification’ screen |
| | | | AND I should see the two types of verification |
| | | | with my current status |
| 2 | Verification | Ability to get | GIVEN I am a user and I have not started |
| | Not Started | more | the identity OR financial verification |
| | | information | WHEN I tap the ‘Verification’ card on the main |
| | | about the | dashboard view THEN I should see the ‘Financial Verification’ |
| | | verification | item with status not started |
| | | process before | AND I should be able to explore the |
| | | starting the | verification flow |
| | | process | |
| 3 | Identity | Ability to see | GIVEN I am a user and |
| | Verification | status and | identity verification has the |
| | accepted | review | status accepted |
| | | document | WHEN I tap the ‘Identity Verification’ item on |
| | | | verification overview screen |
| | | | THEN I should see the document I uploaded |
| | | | AND I should have the ability to take actions |
| | | | off the document |
| 4 | Identity | Ability to see | GIVEN I am a user and |
| | Verification | status and | identity verification has the |
| | declined | review | status declined |
| | | document | WHEN I tap the ‘Identity Verification’ item on |
| | | | verification overview screen |
| | | | THEN I should see the document I uploaded |
| | | | with a reason why my document was declined |
| | | | AND I should have the ability to take actions |
| | | | off the document |
| 5 | Financial | Ability to see | GIVEN I am a user and |
| | Verification | verification | my financial verification has the |
| | accepted | status and | status accepted WHEN I tap the ‘Financial Verification’ item |
| | | review | on verification overview screen |
| | | documents | THEN I should see the verification screen with |
| | | | status for each document |
| 6 | Financial | Ability to see | GIVEN I am a user and |
| | Verification declined | verification | my financial verification has the |
| | | status and | status declined |
| | | review | WHEN I tap the ‘Financial Verification’ item |
| | | documents | on verification overview screen |
| | | | THEN I should see the verification screen with |
| | | | status for each document |
| 7 | Financial | Ability to see | GIVEN I am a user and I am on the verification |
| | Verification | reason | screen |
| | declined | for declined | WHEN I tap a document with |
| | | document | status declined |
| | | | THEN I should see the document I uploaded |
| | | | with a reason why my document was declined |
| | | | AND I should have the ability to take actions |
| | | | off the document |
| 8 | Upload a new | Ability to | GIVEN I am a user and I am on the document |
| | document | upload a new | detail screen |
| | | document if | WHEN I tap the more button and get the action |
| | | document | sheet |
| | | status | AND I select ′Retake′ |
| | | is declined | THEN I should be taken back to the document |
| | | | upload/camera flow |
| | | | AND once complete, land back on the |
| | | | verification screen with the ability to resubmit |

an additional status may be provided for “not_started”.
Verification: according to certain embodiments, end-user verification by the system herein, or “becoming Reali verified”, requires that users are registered, and have uploaded a predetermined set of forms e.g. proof of identification, proof of funds, and pre-approval documentation. Users can, typically, upload these forms in any sequence they wish, and at any point during their search. If a user has selected that he/she has an all cash offer, then the pre-approval letter may be non-required for that user to be Reali Verified)
Once these forms are submitted, a computerized process, or alternatively, human Reali experts, review and approve the verification.
According to certain embodiments, the verification process includes:
Identity—which is a prerequisite to confirm the requested visit
   ID—Proof of ID for the registered user only (even if there are multiple parties on the final contract, typically only confirm the ID of the registered user)
Financial—which is a prerequisite to unlock the ability to place an offer
   ID— any additional proof of IDs for Co-Buyers on the contract
   Letter of Pre-Approval* (unless paying all cash)
   Proof of Funds
      Verification—Identity: an example of a suitable Flow to Upload ID is now described.
      First, example Access Points are described in the following table, table iv.

TABLE iv

| Navigation | Step | Sub-Step Name | CTA/Link |
|---|---|---|---|
| Journey | Find Your Home | Take A Tour | Verify ID |
| Homes | My Listings | Listing Detail Screen | Schedule a Visit |

User Stories, including acceptance criteria therefor, in the third or second to last column, are described in the following table, table v, whose columns respectively represent Title, User Story, Acceptance Criteria, and Notes.
(here and elsewhere, all references to Zeplin are merely by way of example and may be omitted or modified).

TABLE v

| | | | |
|---|---|---|---|
| Visit Homes- | User taps on | GIVEN that I am a user | Zeplin ID Access |
| Verify ID | the Verify ID | AND I tapped on the Visit | Interaction: |
| CTA | CTA from the | Homes sub-task | User will be able to take a |
| | Visit Homes | WHEN I tap on the Verify ID | photo of their ID, upload an |
| | sub-task | CTA | image from their camera roll |
| | screen | THEN a modal window will | or upload a file (ex: pdf) of |
| | | pop up | their ID |
| | | AND an action sheet will | Tapping the back arrow on the |
| | | appear that prompts the user to | modal window will return the |
| | | grant Reali access to his/her | user to the screen where the |
| | | device with the following | modal window was launched |
| | | options | When the user logs in/registers, |
| | | Don't Allow Access | proof of ID with their account |
| | | Ok (Allow Access) | needs to be saved |
| | | | If the user chooses not to |
| | | | register/login, then the user |
| | | | will not be able to save proof |
| | | | of identification in the app |
| 2 | As a user, I do | GIVEN that I am a user | Zeplin ID Access & Zeplin ID |
| Document | not want to | WHEN I tap Don't Allow on | Camera 1 |
| Upload- | give the Reali | the in app alert | |
| Don't Allow | app access to | THEN the in app alert will | |
| Access | my camera | close | |
| | | AND I will return to the | |
| | | modal window | |
| 3 | As a user, I | GIVEN that I am a user | Zeplin ID Access & Zeplin ID |
| Document | want to give | WHEN I tap OK on the in app | Camera 2 |
| Upload- | the Reali app | alert | |
| Allow Access | access to my | AND give Reali access to my | |
| | camera | device | |
| | | THEN I will be able to take a | |
| | | photo of my ID by tapping on | |
| | | the camera icon | |
| 4 | As a user, I | GIVEN I am a user | Zeplin ID Camera 2 & Zeplin ID |
| Document | want to be | WHEN I tap on the camera | Camera 3 |
| Upload-Take | able to use my | icon | |
| A Photo | camera to take | AND I take a photo of my ID | |
| | a photo of the | THEN the proof of ID will be | |
| | required | uploaded into the app | |
| | documenta- | | |
| | tion | | |
| 5 | As a user, I | GIVEN that I am a user | Zeplin ID Camera 1 |
| Document | want to be | WHEN I tap on the Upload a | Zeplin Offer Upload 1 |
| Upload- | able to upload | File link | |
| Upload a File | a file from my | THEN an action sheet will | |
| Link | device | appear over the modal | |
| | folders | window that will allow me to | |
| | | upload via | |
| | | Photos | |
| | | Browse | |
| | | Cancel | |
| 6 | A user selects | GIVEN that I am a user | Zeplin Offer Upload 1 |
| Document | to upload a | WHEN I choose to upload a | |
| Upload- | photo from | photo | |
| Upload via | their device | THEN I will be able to access | |
| Photo | into the app | my camera roll | |
| | | AND select a photo to upload | |
| 7 | A user selects | GIVEN that I am a user | Zeplin Offer Upload 1 |
| Document | to upload a | WHEN I choose to browse the | |
| Upload- | file from their | files on my device to upload | |
| Upload via | device into | my proof of ID | |
| Browse | the app | THEN I will be able to access | |
| | | my device files | |
| | | AND select a file to upload | |
| 8 | A user selects | GIVEN that I am user | Zeplin Offer Upload 1 |
| Document | to not upload | WHEN I choose to cancel my | |
| Upload- | any content | file upload | |
| Cancel | from their | THEN the action sheet will | |
| Upload | device into | close | |
| | the app | AND I will return to the | |
| | | modal window | |
| 9 | As a user, I | GIVEN that I have uploaded a | |
| Document | want my | document | |
| Upload- | documents | WHEN I view the | |
| Document | names to be | documentation | |
| Naming | easily | THEN I will see that the | |
| | recognizable | documents is named as | |
| | and | follows by default | |
| | automatically | id_username | |
| | set | | |
| 10 | As a user, I | GIVEN that I have uploaded | Zeplin ID Camera 3 |
| Document | want to be | an ID | Interaction: |
| Upload- | able to take a | WHEN I tap on the Take | Tapping Take another photo |
| Retaking an | different | another photo link | link restarts the ID upload |
| Image | photo of my | THEN I will be able to take | process |
| | ID before | another photo of my ID | |
| | committing | IF I am satisfied with the | |
| | my upload | image of my ID | |
| | | THEN I will tap on the Yes, It | |
| | | Looks Good CTA | |
| 11 | A user sends | GIVEN that I have uploaded a | Zeplin ID Camera 3 |
| Sending the | their proof of | document | |
| proof of ID to | ID to Reali for | WHEN I tap on the ‘Yes, | |
| Reali | Review | Looks Good’ CTA | |
| | | THEN my uploaded proof of | |
| | | ID will be sent to Reali for | |
| | | review | |
| 12 | A user's proof | GIVEN that I am a user | Zeplin ID Camera 4 |
| ID submission | of ID is | WHEN my proof of ID is | |
| confirmation | successfully | successfully submitted to | |
| screen | submitted to | Reali for Review | |
| | Reali for | THEN I will land on the | |
| | review | submission confirmation. | |
| | | screen | |
| | | AND will see a Continue CTA | |
| 13 | A user taps on | GIVEN that I am a user | Zeplin ID Camera 4 |
| Continue | the Continue | AND I am on the submission | |
| CTA/X icon | CTA/X icon | confirmation screen | |
| | from the | WHEN I tap on the Continue | |
| | Proof of ID | CTA or X icon | |
| | submission | THEN I will be redirected to | |
| | confirmation | the Visit Homes sub-task | |
| | screen | screen | |

Reali Verified—Financial: Any suitable flow may be employed for financial verification e.g. as described herein.
Any suitable flow may be used to Edit a Document (share, edit, rename, and delete) Access Points are described in the following table, table vi.

TABLE vi

| Navigation | Step | Sub-Step Name | CTA/Link |
|---|---|---|---|
| Journey | Find Your Home | Get Reali Verified | Get Verified |
| Homes | My Listings | Listing Detail Screen | Get Reali Verified |

User Stories are described in the following table, table vii.

TABLE vii

| Description | User Story | Notes |
|---|---|---|
| A user taps on | GIVEN that I am a user | Zeplin Verify Home |
| the Get | WHEN I tap on the Get | |
| Verified CTA | Verified CTA on the Get Reali | |
| from the Get | Verified sub-task screen | |
| Reali Verified | THEN I will launch the | |
| sub-task screen | verification flow | |
| | AND land on the Verify | |
| | Home screen | |
| A user taps on | GIVEN that I am a user | Zeplin Verify Home |
| the Get | WHEN I tap on the Get | |
| Verified CTA | Verified CTA on the Listing | |
| on the listing | detail screen | |
| detail screen | THEN I will launch the | |
| | verification flow | |
| | AND I will land on the Verify | |
| | Home screen | |
| As a user, I | GIVEN that I am viewing | Zeplin Verify Home |
| want to know | the Verify Home screen | Interaction: |
| what is | WHEN I scroll up on the | User scrolls up to expose all |
| involved in | screen | steps of the Reali verification |
| getting Reali | THEN I will see that I am | process |
| Verified and | required to submit the | User will have the ability to |
| what | following types of | upload photos, files, pdfs for |
| documents I | documentation to be Reali | each of the required documents |
| am expected to | verified | In order to upload documents, I |
| provide to get | Proof of ID | must be a registered user |
| this process | Pre-Approval Letter | User can upload the documents |
| going | Proof of Funds | in any sequence; in a single or |
| | | across multiple sessions. |
| | | Verification related documents |
| | | that the user uploaded in earlier |
| | | sessions will be visible when |
| | | the user launches the |
| | | Verification flow |
| As a user, | GIVEN that I am viewing | Zeplin Verify Home |
| when I land on | the Verify Home screen | Interaction: |
| the | WHEN I scroll up on the | Proof of ID-multiple files, no |
| Verification | screen | limit |
| home screen, | THEN I will see any historical | Pre-approval-1 file max |
| then I need to | verification documentation that | Proof of Funds-multiple files, |
| see what | I uploaded in prior sessions | no limit |
| verification | | |
| documentation | | |
| I have | | |
| uploaded in the | | |
| past | | |
| As a user, I | GIVEN that I am viewing | Zeplin Verify Home |
| need to be able | the Verify Home screen | |
| to upload an | WHEN I tap on the Upload | |
| image/photo of | Another ID CTA, | |
| my | THEN a modal window will | |
| government | pop up | |
| issued | AND I will receive an in app | |
| identification | alert asking me to grant Reali | |
| | Access to my Camera | |
| As a user, I | GIVEN that I am viewing | Zeplin Pre-Approval 1 |
| need to be able | the Verify Home screen | |
| to upload a | WHEN I tap on the Upload | |
| photo or file of | Pre-Approval CTA, | |
| my pre- | THEN a modal window will | |
| approval letter | pop up | |
| | AND I will receive an in app | |
| | alert asking me to grant Reali | |
| | Access to my Camera | |
| As a user, I | GIVEN that I am viewing | Zeplin Verify All Cash |
| want to | the Verify Home screen | Interaction: |
| indicate that | WHEN I toggle the All Cash | Default setting for the switch is |
| my offer is an | Offer switch to ON | OFF |
| all cash offer | THEN I will not be required to | If All Cash offer is Yes, then the |
| | upload a Pre-Approval letter to | user does not need to submit a |
| | be Reali Verified | Pre-Approval letter to be Reali |
| | | Verified |
| | | If All Cash offer is No, then the |
| | | user has to submit a Pre- |
| | | Approval letter to be Reali |
| | | Verified |
| As a user, I | GIVEN that I am viewing | Zeplin Proof of Funds 1 |
| need to be able | the Verify Home screen | |
| to upload a | WHEN I tap on the Upload | |
| photo or file of | Proof of Funds CTA | |
| my proof of | THEN a modal window will | |
| funds | pop up | |
| documentation | AND I will receive an in app | |
| | alert asking me to grant Reali | |
| | Access to my Camera. | |
| As a user, I do | GIVEN that I am a user | Zeplin Proof of Funds 2 and Zeplin |
| not want to | WHEN I tap Don't Allow on | Pre-Approval 2 |
| give the Reali | the in app alert | |
| app access to | THEN the in app alert will | |
| my camera | close | |
| | AND I will return to the | |
| | modal window | |
| As a user, I | GIVEN that I am a user | Zeplin Proof of Funds 3 and Zeplin |
| want to give | WHEN I tap OK on the in app | Pre-Approval 3 |
| the Reali app | alert | |
| access to my | AND give Reali access to my | |
| camera | device | |
| | THEN I will be able to take a | |
| | photo of my documentation by | |
| | tapping on the camera icon | |
| As a user, I | GIVEN it am a user | Zeplin Proof of Funds 3 and Zeplin |
| want to be able | AND I have given Reali access | Pre-Approval 3 |
| to use my | to my device | |
| camera to take | WHEN I tap on the camera | |
| a photo of the | icon | |
| required | AND I take a photo of my ID | |
| documentation | THEN a photo of | |
| | documentation will be taken | |
| | and uploaded into the app | |
| As a user, I | GIVEN that I am a user | Zeplin Proof of Funds 2 and Zeplin |
| want to be able | WHEN I tap on the Upload a | Pre-Approval 2 |
| to upload a file | File link | |
| from my | THEN an action sheet will | |
| device folders | appear over the modal window | |
| | that will allow me to upload | |
| | via | |
| | Photos | |
| | Browse | |
| | Cancel | |
| A user selects | GIVEN that I am a user | Zeplin Offer Upload 1 |
| to upload a | WHEN I choose to upload a | |
| photo from | photo | |
| their device | THEN I will be able to access | |
| into the app | my camera roll | |
| | AND select a photo to upload | |
| A user selects | GIVEN that I am a user | Zeplin Offer Upload 1 |
| to upload a file | WHEN I choose to browse the | |
| from their | files on my device to upload | |
| device into the | the required documentation | |
| app | THEN I will be able to access | |
| | my device files | |
| | AND select a file to upload | |
| A user selects | GIVEN that I am user | Zeplin Offer Upload 1 |
| to not upload | WHEN I choose to cancel my | |
| any content | file upload | |
| from their | THEN the action sheet will | |
| device into the | close | |
| app | AND I will return to the | |
| | modal window | |
| As a user, I | GIVEN that I have uploaded a | Zeplin Proof of Funds 4 and Zeplin |
| want the | document | Pre-Approval 4 |
| default name | WHEN I view the | Notes: |
| of my | documentation | 1. Users may upload more than |
| documents to | THEN I will see that the | one proof of funds document at |
| help me keep | documents have the following | a time, Naming convention for |
| them | default naming protocol: | multiple documents would be |
| organized | proofoffunds_usemame | 1. proofoffunds_1username |
| | preapproal_usemame | 2. proofoffudns_2username |
| | identification_username | |
| As a user, I | GIVEN that I have uploaded a | Zeplin Proof of Funds 4 and Zeplin |
| want to be able | document | Pre-Approval 4 |
| to take a | WHEN I tap on the Take | Interaction: |
| different photo | another photo link | Tapping Take another photo |
| of my | THEN I will be able to take | link restarts the document |
| documentation | another photo of my | upload process for that |
| before | documentation | document |
| committing my | IF I am satisfied with the | |
| upload | image of my documentation | |
| | THEN I will tap on the Yes, It | |
| | Looks Good CTA | |
| As a user, I | GIVEN that have uploaded a | Zeplin Proof of Funds 4 and Zeplin |
| want to | document | Pre-Approval 4 |
| confirm that I | WHEN I tap on the Yes, Looks | Interaction: |
| have uploaded | Good CTA | Submit Reali Verification CTA |
| a document | THEN the I will land on | is grayed out by default |
| | the Verify Home screen | CTA turns active when the user |
| | AND I will be able to see what | has uploaded all of the required |
| | documentation I have uploaded | documentation |
| | and what documentation I need | All verification documentation |
| | to upload | uploaded in this and past |
| | | sessions will be shown |
| As a user, I | GIVEN that I have uploaded | Zeplin Verify Complete |
| want to submit | all of the required verification | |
| my request to | documents | |
| be Reali | WHEN I tap on the Submit | |
| verified to | Reali Verification CTA | |
| Reali for | THEN my request for | |
| review | verification will be sent to | |
| | Reali | |
| | AND I will land on | |
| | the Verification | |
| | Submitted confirmation screen | |
| As a user, I | GIVEN that I have uploaded | Zeplin Single Document Review |
| want to be able | one or more of the required | Screen |
| to review my | verification documents | Interaction: |
| documentation | WHEN I tap on the document | To return to the Verify |
| before | from the verification screen | Complete screen, the user will |
| submitting for | THEN the document will open | need to tap on the back arrow |
| verification | in full page view | Tapping on the More options |
| | AND I will be able to review | icon will launch an action |
| | the document | sheet (2.21) |
| A user taps on | GIVEN that I am on the Single | Action sheet from single document |
| the more | Document Review Screen | view |
| options icon | WHEN I tap on the More | |
| from the single | Options Icon | |
| document | THEN an action sheet will | |
| review screen | appear | |
| | AND I will see the following | |
| | options: | |
| | Share | |
| | Rename | |
| | Edit | |
| | Delete | |
| As a user, I | GIVEN that I tapped on the | Action sheet in single document view |
| want to be able | More Options Icon on | Delete document confirmation |
| to delete a | the Single Document Review | Interaction: |
| document that | Screen | Tapping Cancel closes the alert |
| I have | AND I want to delete one of | Tapping Delete-deletes the |
| uploaded | my documents | uploaded document and returns |
| | WHEN I tap on the Delete | the user to the Verify |
| | option on the Action Sheet | Home screen |
| | THEN I will receive an in app | |
| | warning | |
| | AND I will need to tap Delete | |
| | to Delete my uploaded | |
| | document | |
| As a user, I | GIVEN that I tapped on the | Action sheet with rename selected |
| want the | More Options Icon on | Rename document alert |
| ability to | the Single Document Review | Interaction: |
| rename my | Screen | User taps on document name |
| document | AND I want to rename one of | cell |
| | my documents | Keyboard is launched |
| | WHEN I tap on the Rename | User updates document name |
| | option on the Action Sheet | Tapping Cancel closes the alert |
| | THEN I will receive an in app | |
| | warning | |
| | AND I will need to tap on the | |
| | document name to rename the | |
| | document | |
| | THEN I will need to tap on the | |
| | Rename option to commit the | |
| | document name change | |
| As a user, I | GIVEN that I tapped on the | Action sheet with share selected |
| want the | More Options Icon on | Share activity sheet |
| ability to share | the Single Document Review | Interaction: |
| my documents | Screen | Tapping cancel will close the |
| (adding this as | AND I want to share one of my | action sheet |
| a work around | documents | Tapping outside of the action |
| so users can | WHEN I tap on the Share | sheet will close the action sheet |
| email | option on the Action Sheet | |
| documents to | THEN my devices share | |
| themselves for | options action sheet will pull | |
| review if they | up | |
| prefer viewing | AND I will be able to share my | |
| on desktop) | document | |
| As a user, I | GIVEN that I have uploaded a | Zeplin Proof of Funds 4 and Zeplin |
| want the | document | Pre-Approval 4 |
| ability to edit | IF I do not like the way that | |
| my | document looks | |
| documentation | WHEN I tap on the Take | |
| | Another Picture link | |
| | THEN I will be able to retake | |
| | the photo of my | |
| | documentation | |
| | AND Upload the new photo | |
| | into the app | |
| As a user, I | GIVEN that I have | Zeplin Verification Submitted |
| want to know | successfully submitted my | |
| that my request | verification request to Reali | |
| to be Reali | WHEN I land on | |
| verified was | the Verification | |
| successfully | Submitted screen | |
| submitted to | AND I tap on Continue | |
| Reali | THEN I will be redirected to | |
| | the screen where I initiated the | |
| | Verification flow | |

STATUSES are described in the following table, table viii.

TABLE viii

| | | Status | | | | | |
|---|---|---|---|---|---|---|---|
| | | Update | | Mobile | Mobile | Echo | Echo |
| # | User Story | Trigger | Old Status Equivalent | Status | Notification | Status | Notification |
| 1 | User uploads | Take a | PENDING_REVIEW | pending | NA | pending | Badge, |
| | and submits | Tour | | | | | Push |
| | identification in | Journey | | | | | |
| | app from | step | | | | | |
| | Journey | | | | | | |
| 2 | Experts | Verification | IN_REVIEW_BY_EXPERT | in | Badge | working | NA |
| | changes status | request | | review | | | |
| | to working in | table | | | | | |
| | order to view | | | | | | |
| | documents | | | | | | |
| 3 | Expert | Verification | ACCEPTED | accepted | Badge, | accepted | NA |
| | confirms ID | modal | | | Push | | |
| | and approves | | | | | | |
| | identity | | | | | | |
| | verification | | | | | | |
| 4 | Expert | Verification | REJECTED | rejected | Badge, | rejected | NA |
| | denies identity | modal | | | Push | | |
| | verification | | | | | | |
| 5 | Document | Automatically | EXPIRED | expired | Badge, | expired | NA |
| | required | when the | | | Push | | |
| | verification | first | | | | | |
| | expires | document | | | | | |
| | | expires | | | | | |

DOCUMENT CHANGES: Document changes may be reflected immediately upon a user's action. Typically, changes can be made only when the user's verification is not currently in review (Not in Working status). Typically, the submission button's are only enabled when the user's verification isn't currently in review (Not in Working status).

### Dashboard_documents

This option allows an end-user a Quick look at documents and status updates.
Any suitable user flows may be employed.
Requirements, all or any subset of which may be applicable in a given embodiment, are described in the following table, table ix:

TABLE ix

| # | Title | Description | User Story |
|---|---|---|---|
| 1 | Documents | Ability to see | GIVEN I am a user |
| | Overview | documents | WHEN I tap the 'Documents' card on |
| | | and status | the main dashboard view |
| | | | THEN I should see the ‘Documents’ |
| | | | screen |
| | | | AND I should see all documents I have |
| | | | requested or completed, sorted with |
| | | | most recent status change on top |
| 2 | Documents | Ability to see | GIVEN I am a user and I am on the |
| | Icon | what type of | documents screen |
| | | document you | WHEN I have documents |
| | | have | THEN I should see an icon for |
| | | | the following types of documents: |
| | | | PNG |
| | | | PDF |
| | | | DOC |
| 3 | Document | Ability to | GIVEN I have previously requested |
| | Detail | review | comps on a property |
| | View | document and | AND the request is complete |
| | | take actions | WHEN I tap the document |
| | | off a | THEN the ‘Property Report’ for that |
| | | document | listing should open |
| 4 | Document | Ability to | GIVEN I am on the documents screen |
| | Search | search for a | AND I tap the search icon |
| | | document | THEN I will get a search screen |
| | | | AND be able to search by document title |

### Declined Reasons

| Document | | |
|---|---|---|
| Type | Field | Value |
| Pre- | Reason | Document expired (must be less than 90 days old) |
| Approval | | |
| | | Illegible |
| | | Upload pre-approval (pre-qualifications not accepted |
| | | Missing information |
| | | Other |
| Proof of | Reason | ID Expired |
| ID | | |
| | | Illegible |
| | | Not a Valid ID, end user needs to upload or take a |
| | | picture of a government issued ID such as a Driver's |
| | | License or Passport |
| | | Missing Information |
| Proof of | Reason | Document expired (must be less than 30 days old) |
| Funds | | |
| | | Illegible |
| | | Missing information (upload recent bank statement) |
| | | Other |

### Dashboard_Team

Requirements, all or any subset of which may be applicable in a given embodiment, are described in the following table, table x:

TABLE x

| # | Title | Description | User Story | Notes |
|---|---|---|---|---|
| 1 | Team | Ability to see all | GIVEN I am a user | Team |
| | Overview | Reali Experts | WHEN I tap the ‘Team’ card | Overview |
| | | associated with | on the main dashboard view | Screen |
| | | your Journey | THEN I should see the ‘Team’ | Multiple |
| | | | screen | Team |
| | | | AND I should see all Experts | Members |
| | | | associated with my Journey | |
| 2 | Team | Empty State | GIVEN I am a user | |
| | Overview | | WHEN I have no team | |
| | | | members associated with my | |
| | | | Journey | |
| | | | THEN I should see an empty | |
| | | | state | |

User stories for Buyer Journey's Step 1: Find Home are described below in table xi.

TABLE xi

| Title | Acceptance Criteria | Notes |
|---|---|---|
| Step 1 Find | GIVEN that I am a user | Zeplin tasks/prepare |
| Home Tasks | WHEN I tap on Step 1 Find | Interaction: |
| Overview | Home | Tapping on the Journey icon in |
| screen. | FROM the Journey Steps menu | the header of the screen will |
| User taps on | screen | launch the Journey Steps Menu |
| Step 1 Find | THEN I will land on the Find | screen (Zeplin tasks/menu) |
| Home from the | Home tasks overview screen | User has the ability to scroll |
| Journey Steps | AND see the following sub- | up/down to view more/less |
| Menu screen | tasks | content on the journey sub-tasks |
| | Build Shortlist | for this step |
| | Visit Homes | Tapping on any of the sub-tasks |
| | Request Comps | outlined on screen and will |
| | Get Verified | redirect the user to the sub-step |
| | | screen |
| | | When on the sub-task screen, |
| | | tapping the back arrow will land |
| | | the user back on the Tasks |
| | | Overview screen |
| 2. | GIVEN that I am a user | Zeplin tasks/shortlist |
| Build Shortlist | AND I am on the Step 1 Find | Interaction: |
| sub-task screen. | Home tasks overview screen | CTAs will be enabled for all |
| User taps on | WHEN I tap on the Build | users. |
| Build Shortlist | Shortlist sub-task | Tapping on Call Us will launch a |
| sub-task from | THEN I will land on the Build | call on the user's device |
| the Find Home | Shortlist sub-task screen | Tapping on Chat will redirect the |
| tasks overview | AND I will have the ability to | user to the Chat flow |
| screen | tap CTA's | User taps on the back arrow in |
| | Chat | the header to return to the Step 1 |
| | Call Us | Find Home Tasks Overview |
| | Build Shortlist | screen |
| 3. | GIVEN that I am a user | Zeplin tasks/shortlist |
| Build Shortlist | AND I am on the Build | |
| CTA. | Shortlist sub-task screen | |
| User taps on | WHEN I tap on the Build | |
| Build Shortlist | Shortlist CTA | |
| CTA from the | THEN I will be redirected to | |
| Build Shortlist | Homes/MyFeed | |
| sub-task screen | | |
| 4. | GIVEN that I am a user | Zeplin tasks/visit |
| Visit Homes | AND I am on the Step 1 Find | Interaction: |
| sub-task screen. | Home tasks overview screen | CTAS will be enabled for all |
| User taps on | WHEN I tap on Visit Homes | users. |
| Visit Homes | sub-task | Tapping on the Schedule a visit |
| sub-task from | THEN I will land on the Visit | CTA will redirect the user to the |
| the Find Home | Homes sub-task screen | Schedule flow |
| tasks overview | AND will have the ability to | Tapping on Verify ID will pull |
| screen | tap CTA's | up an action sheet that the user |
| | Chat | can utilize to upload their ID |
| | Call Us | lser taps on the back arrow in |
| | Schedule a Visit | the header to return to the Step 1 |
| | Verify ID | Find Home Tasks Overview |
| | | screen |
| 5. | GIVEN that I am a user | Zeplin tasks/visit |
| Schedule a | AND I am on the Visit Homes | |
| Visit CTA. | sub-task screen | |
| User taps on | WHEN I tap on the Schedule | |
| the Schedule a | Visit CTA | |
| visit CTA from | THEN I will be redirected to | |
| the Visit | the Homes/Shortlist screen | |
| Homes sub-task | | |
| screen | | |
| 6. | GIVEN that I am a user | Zeplin tasks/visit > Need action sheet |
| Visit Homes- | AND I tapped on the Visit | wire > Need image upload |
| Verify ID | Homes sub-task | wire > signup/1 |
| CTA. | WHEN I tap on the Verify ID | Interaction: |
| User taps on | CTA | Proof of Identification is required |
| the Verify ID | THEN an action sheet will | in order for a user to schedule a |
| CTA from the | appear that allows me to take a | visit. |
| Visit Homes | photo of my ID | User will be able to take a photo |
| sub-task screen | GIVEN that I chose to upload | of their ID, upload an image |
| | an image, file, pdf of my ID | from their camera roll or upload |
| | WHEN I tap on one of those | a file (ex: pdf) of their ID |
| | options | Tapping on any of the options in |
| | THEN I will receive an alert | the action sheet prompts an alert |
| | asking me to confirm that I | requesting that the user allow |
| | want to give Reali access to my | Reali to access their camera, |
| | device | camera role, files. |
| | IF that I choose to allow | After uploading the file, Reali |
| | Reali access to my | wants the user to be prompted to |
| | device | register/login so that an image |
| | THEN I will be able to | may be saved to their account |
| | take and take a photo or | Tapping outside of the action |
| | upload a file of my ID | sheet will close the sheet |
| | IF I choose to not allow | When they login/register. Reali |
| | Reali access to my | wants to save the proof of ID |
| | device | with their account |
| | THEN I the alert will | If they choose not to |
| | close, the modal will | register/login, then they will not |
| | close, and the I will stay | be able to save their proof of |
| | to the Visit Homes sub- | identification in the app |
| | task overview screen | If the user chooses to not allow |
| | GIVEN that I gave Reali access | Reali access their device to |
| | to my device | upload a copy of their ID, then |
| | WHEN I have successfully | the alert and modal will close and |
| | uploaded my image | the user will remain on the |
| | THEN I will be prompted to | tasks/visit screen. |
| | sign up/sign in to save this | |
| | image with my account | |
| Request Comps | GIVEN that I am a user | Zeplin tasks/comps |
| sub-task screen | AND I am on the Step 1 Find | Interaction: |
| | Home tasks overview screen | CTAs will be enabled for all |
| | WHEN I tap on the Request | users. Logged in and anonymous |
| | Comps sub-task | Tapping on Call will launch a |
| | THEN I will land on the | call on the users device |
| | Request Comps Overview | Tapping on Chat will redirect the |
| | screen | user to the Chat flow |
| | AND I will have the ability to | Tapping on Request Info CIA |
| | tap on CTA's | will redirect the user to |
| | Chat | Homes/Wishlist |
| | Call | User taps on the <icon in the |
| | Request info | header to return to the Step 1 |
| | | Find Home Overview Screen |
| Request Comps- | GIVEN that it am a user | Zeplin tasks/comps |
| Request Info | AND I tapped on the Request | Interaction: |
| CTA | Comps sub-task | If the user is a registered user, |
| | WHEN I tap on the Request | with favorited listings, then they |
| | Comps CTA | will to go to the Wishlist section |
| | THEN I will be redirected to | of the Listings Page. |
| | the Homes/Wishlist screen | If they are an |
| | | unregistered/unlogged in user |
| | | who has not favorited any |
| | | listings, then they will still be |
| | | taken to the Wishlist section so |
| | | that they can be informed that |
| | | this is where they will find their |
| | | favorites. |
| Get Verified | GIVEN that I am a user | Zeplin tasks/verified |
| sub-task screen | AND I am on the Step 1 Find. | Interaction: |
| | Home tasks overview screen | CTAs will be enabled for all |
| | WHEN I tap on the Get | users. Logged in and anonymous |
| | Verified sub-task | Tapping on Call will launch a |
| | THEN I will land on the Get | call on the users device |
| | Verified Overview screen | Tapping on Chat will redirect the |
| | AND I will have the ability to | user to the Chat flow |
| | tap on CTA's | Tapping on Get Verified info |
| | Chat | CTA will redirect the User Flow- |
| | Call | Verification |
| | Get Verified | Tapping on Get Pre-Approved |
| | Get Pre-Approved | CTA will redirect the user to the |
| | | Mortgage Flow |
| | | User taps on the <icon in the |
| | | header to return to the Step 1 |
| | | Find Home Overview Screen |
| Get Verified | GIVEN that I am a user | Zeplin tasks/verified |
| CTA | AND I tapped on the Get | Interaction: |
| | Verified Sub-task | CTA Destination-Redirect User |
| | WHEN I tap on the Get | Flow-Verification |
| | Verified CTA | |
| | THEN I will be directed down | |
| | the Verification flow | |
| Get Pre- | GIVEN that I am a user | Zeplin tasks/verified |
| Approved CTA | AND I tapped on the Get | Interaction: |
| | Verified Sub-task | CTA Destination-Redirect User |
| | WHEN I tap on the Get Pre- | Flow-Mortgage |
| | Approved CTA | |
| | THEN I will be directed down | |
| | the Mortgage flow | |
| Chat Button | GIVEN that I am a user | Zeplin needs wires |
| | WHEN I tap on the chat button | Interaction: |
| | from any screen inside of the | |
| | buyers journey sub-task screens | |
| | IF I am signed in to the app | |
| | THEN a chat window will | |
| | open | |
| | AND I will be able to chat with | |
| | Reali | |
| | GIVEN that I am a user | |
| | WHEN I tap on the chat button | |
| | from any screen inside of the | |
| | buyers journey sub-task screens | |
| | IF I am not a signed in to the | |
| | app | |
| | THEN I will be prompted to | |
| | sign in/sign up | |
| | AND I will not be able to chat | |
| | with Reali until I have signed in | |
| | or signed up | |
| Call Button | GIVEN that I am a user | Zeplin action/call |
| | WHEN I tap on the call button | Interaction |
| | from any screen inside of the | CTA Destination Redirect-Call |
| | buyers journey sub-task screens | Tapping on the Call CTA will |
| | THEN I expect to be able to | launch a call to Reali from the |
| | call Reali from my device | users device |
| | GIVEN that I have tapped the | The user should receive an app |
| | call button | alert confirming that they want to |
| | WHEN I see the in app alert | call us |
| | AND I select Call | |
| | THEN a call will be initiated | |
| | with Reali | |
| | GIVEN that I have tapped the | |
| | call button | |
| | WHEN I see the in app alert | |
| | AND I select Cancel | |
| | THEN the alert will be closed | |
| | AND a call will not be initiated | |
| | with Reali | |
| Sub-Task | GIVEN that I am an user | Zeplin tasks/status |
| Status Indicator | WHEN I complete a sub-task | Interaction: |
| | THEN I want to see that | For the MVP the only status |
| | reflected on the task overview | options that are supported are |
| | screen | not-started or complete |
| | | Not started tasks will have no |
| | | indicator |
| | | Complete tasks will have a green |
| | | check mark to indicate that the |
| | | status for that task is complete |
| | | A user may have all sub- |
| | | status in non-started |
| | | status, a combination of |
| | | not-started and completed |
| | | statuses, and all sub- |
| | | statuses in completed |
| | | status |
| Sub-task | GIVEN that I am a user | Zeplin tasks/collapse |
| collapse | WHEN I scroll my screen up | |
| | while on the Tasks Overview | |
| | screen | |
| | THEN the image will collapse | |
| | AND I will see header and the | |
| | sub-tasks for that section | |
| | BUT not the Image | |

User stories for Buyer Journey—Step 2: make offer are described in the following table,

TABLE xii

| Title | Acceptance Criteria | Notes |
|---|---|---|
| Step 2 | GIVEN that I am a user | Zeplin tasks/make an offer |
| Make An | WHEN I tap on Step 2 Make | Interaction: |
| Offer | an Offer | Tapping on the Journey icon |
| Tasks | FROM the Journey Steps | in the header of the screen |
| Overview | menu screen | will launch the Journey Steps |
| screen. | THEN I will land on the | Menu screen |
| User taps | Make an Offer tasks overview | (Zeplin tasks/menu) |
| on Step 2 | screen | User has the ability to scroll |
| Make an | AND see the following sub- | up/down to view more/less |
| Offer | tasks | content on the journey sub- |
| from the | Draft an Offer | asks for this step |
| Journey | Sign and Submit | Tapping on any of the sub- |
| Steps | Negotiate Offer | tasks outlined on screen and |
| Menu | Win! | will redirect the user to the |
| screen | | sub-step screen |
| | | When on the sub-task screen, |
| | | tapping the back arrow will |
| | | land the user back on the |
| | | Tasks Overview screen |
| Draft | GIVEN that I am a user | Zeplin tasks/draft an offer |
| Offer. | AND I am on the Step 2 Make | Interaction: |
| User taps | an Offer tasks overview screen | CTAs will be enabled for all |
| on Draft | WHEN I tap on the Draft an | users. |
| an Offer | Offer sub-task | Tapping on Call will launch |
| sub-task | THEN I will land on the Draft | a call on the users device |
| from the | an Offer sub-task screen | Tapping on Chat will redirect |
| Make an | AND I will have the ability | the user to the Chat flow |
| Offer | to tap CTA's | User taps on the <icon in the |
| tasks | Chat | header to return to the Step 2 |
| overview | Call | Make an Offer Overview |
| screen | Draft an Offer | Screen |
| Draft | GIVEN that I am a user | Zeplin tasks/draft an offer |
| Offer- | AND I am on the Draft an | Interaction: |
| Go To | offer sub-task screen | CTA Destination Redirect- |
| Short | WHEN I tap on the Draft an | Listings/Wishlist |
| List | Offer CTA | |
| CTA. | THEN I will be directed to | |
| User taps | the Home/Wishlist screen | |
| on the | | |
| Draft | | |
| Offer | | |
| CTA | | |
| from the | | |
| Draft an | | |
| Offer | | |
| sub-task | | |
| screen | | |
| Sign & | GIVEN that I am a user | Zeplin tasks/signandsubmit |
| Submit. | AND I am on the Step 2 Make | Interaction: |
| User taps | an Offer tasks overview screen | CTA will be grayed out if 1) |
| on the | WHEN I tap on the Sign and | user is not logged in or 2) |
| Sign and | Submit sub-task | user is logged in but does |
| Submit | THEN I will land on the Sign | not have an open active |
| sub- | and Submit sub-task screen | offer |
| task from | AND I will see CTAs to: | CTA will be enabled if 1) |
| the Make | Call | user is logged in and has an |
| an Offer | Chat | open active offer |
| tasks | Review Offer | |
| overview | GIVEN that I am a user | |
| screen | WHO is not signed in | |
| | OR who is signed in, but does | |
| | not have an open active offer | |
| | WHEN I land on the Sign and | |
| | Submit sub-task screen | |
| | THEN the Review Offer CTA | |
| | will be inactive | |
| | AND I will not be able to | |
| | tap on it | |
| | GIVEN that I am a user | |
| | WHO is signed in | |
| | AND who has an open active | |
| | offer | |
| | WHEN I land on the Sign and | |
| | Submit sub-task screen | |
| | THEN the Review Offer CTA | |
| | will be enabled | |
| | AND I will be able to tap on it | |
| Sign and | GIVEN that I am a user | Zeplin tasks/signandsubmit |
| Submit | WHO is signed in | Interaction: |
| screen- | AND who has an open active | CTA Destination Redirect- |
| Review | offer | Listings/MyOffer |
| Offer | WHEN I tap on the Review | |
| CTA | Offer CTA | |
| | THEN I will be directed to the | |
| | Home/MyOffer screen where I | |
| | can review my offer | |
| Negotiate | GIVEN that I am a user | Zeplin tasks/negotiate |
| Offer | AND I am on the Step 2 Make | Interaction: |
| | an Offer tasks overview screen | CTA will be grayed out if 1) |
| | WHEN I tap on the Negotiate | user is not logged in or 2) |
| | Offer sub-task | user is logged in but does not |
| | THEN I will land on the | have an open active offer |
| | Negotiate Offer sub- | CTA will be enabled if 1) |
| | task screen | user is logged in and has |
| | AND I will see CTAs to: | an open active offer |
| | Call | Tapping on Call will launch a |
| | Chat | call on the users device |
| | Review Offer | Tapping on Chat will redirect |
| | GIVEN that I am a user | the user to the Chat flow |
| | WHO is not signed in | User taps on the <icon in the |
| | OR who is signed in, but does | header to return to the Step 2 |
| | not have an open active offer | Make an Offer Overview |
| | WHEN I land on the Negotiate | Screen |
| | Offer sub-task screen | |
| | THEN the Review Offer CTA | |
| | will be inactive | |
| | AND I will not be able to | |
| | tap on it | |
| | GIVEN that I am a user | |
| | WHO is signed in | |
| | AND who has an open active | |
| | offer | |
| | WHEN I land on the Negotiate | |
| | Offer sub-task screen | |
| | THEN the Review Offer CTA | |
| | will be enabled | |
| | AND I will be able to tap on it | |
| Negotiate | GIVEN that I am a user | Zeplin tasks/negotiate |
| Offer- | WHO is signed in | Interaction: |
| Review | AND who has an open active | CTA Destination Redirect- |
| Offer | offer | Listings/MyOffer |
| CTA | WHEN I tap on the Review | |
| | Offer CTA | |
| | THEN I will be directed to the | |
| | Home/MyOffer screen where I | |
| | can review my offer | |
| Win | GIVEN that I am a user | Zeplin tasks/win |
| | AND I am on the Step 2 Make | Interaction: |
| | an Offer tasks overview screen | CTA will be grayed out if 1) |
| | WHEN I tap on the Win sub- | user is not logged in or 2) |
| | task | user is logged in but does |
| | THEN I will land on the Win | not have an accepted/ |
| | sub-task screen | ratified offer |
| | AND I will see CTAs to: | CTA will be enabled if 1) |
| | Call | user is logged in and has an |
| | Chat | accepted/ratified offer |
| | Review Offer | Tapping on Call will launch a |
| | GIVEN that I am a user | call on the users device |
| | WHO is not signed in | Tapping on Chat will redirect |
| | OR who is signed in, but does | the user to the Chat flow |
| | not have an open active offer | User taps on the <icon in the |
| | WHEN I land on the Win sub- | header to return to the Step 2 |
| | task screen | Make an Offer Overview |
| | THEN the Review Offer CTA | Screen |
| | will be inactive | |
| | AND I will not be able to | |
| | tap on it | |
| | GIVEN that I am a user | |
| | WHO is signed in | |
| | AND who has an open active | |
| | offer | |
| | WHEN I land on the Win sub- | |
| | task screen | |
| | THEN the Review Offer CTA | |
| | will be enabled | |
| | AND I will be able to tap on it | |
| Win | GIVEN that I am a user | Zeplin tasks/win |
| Review | WHO is signed in | Interaction: |
| Offer | AND who has an open active | CTA Destination Redirect- |
| CTA | offer | Listings/MyOffer |
| | WHEN I tap on the Review | |
| | Offer CTA | |
| | THEN I will be directed to the | |
| | Home/MyOffer screen where I | |
| | can review my offer | |
| Chat | GIVEN that I am a user | Zeplin need wires |
| Button | WHEN I tap on the chat | Interaction: |
| | button from any screen | |
| | inside of the buyers | |
| | journey sub-task screens | |
| | IF I am signed in to the app | |
| | THEN a chat window will | |
| | open | |
| | AND I will be able to chat | |
| | with Reali | |
| | GIVEN that I am a user | |
| | WHEN I tap on the chat button | |
| | from any screen inside of the | |
| | buyers journey sub-task screens | |
| | IF I am not a signed in to the | |
| | app | |
| | THEN I will be prompted | |
| | to sign in/sign up | |
| | AND I will not be able to chat | |
| | with Reali until I have signed | |
| | in or signed up | |
| Call | GIVEN that I am a user | Zeplin action/call |
| Button | WHEN I tap on the call | Interaction |
| | button from any screen inside | CTA Destination Redirect- |
| | of the buyers journey | Call |
| | sub-task screens | Tapping on the Call CTA |
| | THEN I expect to be able to | will launch a call to Reali |
| | call Reali from my device | from the user's device |
| | GIVEN that I have tapped the | The user should receive an |
| | call button | app alert confirming that |
| | WHEN I see the in app alert | Reali wants to call the user |
| | AND I select Call | |
| | THEN a call will be initiated | |
| | with Reali | |
| | GIVEN that I have tapped the | |
| | call button | |
| | WHEN I see the in app alert | |
| | AND I select Cancel | |
| | THEN the alert will be dosed | |
| | AND a call will not be | |
| | initiated with Reali | |
| Sub-Task | GIVEN that I am an user | Zeplin tasks/status |
| Status | WHEN I complete a sub-task | Interaction: |
| Indicator | THEN I want to see that | For the MVP the only status |
| | reflected on the task overview | options that will be supported |
| | screen | are not-started or complete |
| | | Not started tasks will have |
| | | no indicator |
| | | Complete tasks will have a |
| | | green check mark to indicate |
| | | that the status for that task is |
| | | complete |
| | | A user may have all sub- |
| | | status in non-started status, a |
| | | combination of not-started |
| | | and completed statuses, |
| | | and all sub-statuses in |
| | | completed status |
| Sub-task | GIVEN that I am a user | Zeplin tasks/collapse |
| collapse | WHEN I scroll my screen up | |
| | while on the Tasks Overview | |
| | screen | |
| | THEN the image will collapse | |
| | AND I will see header and the | |
| | sub-tasks for that section | |
| | BUT not the Image | |

Buyer Journey—Step 3: Close User Stories are shown in the following table,

TABLE xiii

| Title | | |
|---|---|---|
| and user story | Acceptance Criteria | Notes |
| 1. | GIVEN that I am a user | Zeplin tasks/closing |
| Step 3 Win and | WHEN I tap on Step 3 Win | Interaction: |
| Close Tasks | and Close | Tapping on the |
| Overview screen. | FROM the Journey Steps | Journey icon in the |
| User taps on | menu screen | header of the screen |
| Step 3 Win and | THEN I will land on the Win | will launch the |
| Close from | and Close tasks overview | Journey Steps |
| the Journey Steps | screen | Menu screen |
| Menu screen | AND see the following sub- | (Zeplin tasks/menu) |
| | tasks | User has the ability to |
| | Escrow | scroll up/down to view |
| | Contingency Period | more/less content on |
| | Final Walkthrough | the journey sub-tasks |
| | Closing | for this step |
| | Cash Back | Tapping on any |
| | | of the sub-tasks |
| | | outlined on screen and |
| | | will redirect the user |
| | | to the sub-step screen |
| | | When on the sub-task |
| | | screen, tapping the |
| | | back arrow will |
| | | land the user |
| | | back on the Tasks |
| | | Overview screen |
| 2. | GIVEN that I am a user | Zeplin tasks/ |
| Escrow | AND I am on the Step 3 Win | Escrow |
| User taps on | and Close tasks overview | |
| Escrow sub- | screen | |
| task from the | WHEN I tap on the Escrow | |
| Win and Close | sub-task | |
| Tasks overview | THEN I will land on the | |
| screen | Escrow sub-task screen | |
| | AND I will have the ability to | |
| | tap CTA's | |
| | Chat | |
| | Call | |
| As a user, when I | GIVEN that I am a user | Zeplin tasks/ |
| tap on the | AND I am on the Step 3 Win | contingency |
| Contingency | and Close tasks overview | |
| period sub-task, | screen | |
| I want to | WHEN I tap on the | |
| learn more about | Contingency Period sub-task | |
| what a | THEN I will land on the | |
| Contingency | Contingency Period sub-task | |
| period is. | screen | |
| User will see a | AND I will have the ability to | |
| Contingency | tap CTA's | |
| period | Chat | |
| overview screen | Call | |
| where they will | | |
| learn more about | | |
| what a | | |
| Contingency | | |
| period is. | | |
| User will have | | |
| the ability to tap | | |
| buttons to Chat | | |
| or Call Reali | | |
| 4. Final | GIVEN that I am a user | Zeplin tasks/ |
| Walkthrough | AND I am on the Step 3 Win | finalwt |
| As a user, when | and Close tasks overview | |
| I tap on the Final | screen | |
| Walkthrough | WHEN I tap on the Final | |
| sub-task, I want | Walkthrough sub-task | |
| to learn more | THEN I will land on the Final | |
| about what a final | Walkthrough sub-task screen | |
| walkthrough is. | AND I will have the ability to | |
| User will see a | tap CTA's | |
| Final Walk- | Chat | |
| through overview | Call | |
| screen where | | |
| they will learn | | |
| more about | | |
| what the Final | | |
| Walkthrough is. | | |
| User will have | | |
| the ability to tap | | |
| buttons to Chat | | |
| or Call Reali | | |
| 5. | GIVEN that I am a user | Zeplin tasks/ |
| Closing | AND I am on the Step 3 Win | closing |
| As a user, when | and Close tasks overview | |
| I tap the Closing | screen | |
| sub-task, I want | WHEN I tap on the Closing | |
| to learn more | sub-task | |
| about what is | THEN I will land on the | |
| involved in the | Closing sub-task screen | |
| Closing process. | AND I will have the ability to | |
| User will see to | tap CTA's | |
| the Closing | Chat | |
| overview screen | Call | |
| where they will | | |
| learn more about | | |
| the closing | | |
| User will have | | |
| the ability to tap | | |
| buttons to Chat | | |
| or Call Reali | | |
| 6. | GIVEN that I am a user | Zeplin tasks/ |
| Cash Back | AND I am on the Step 3 Win | closing |
| As a user, when | and Close tasks overview | |
| I tap the Cash- | screen | |
| back sub-task, | WHEN I tap on the Cash | |
| I want to learn | Back sub-task | |
| more about how | THEN I will land on the Cash | |
| the Cashback | Back sub-task screen | |
| option works. | AND I will have the ability to | |
| User will see a | tap CTA's | |
| Cashback | Chat | |
| overview | Call | |
| screen where they | | |
| will learn more | | |
| about how it | | |
| works. | | |
| User will | | |
| have the ability | | |
| to tap buttons | | |
| to Chat or | | |
| Call Reali | | |
| 7. | GIVEN that I am a user | Zeplin need wires |
| Chat Button | WHEN I tap on the chat | |
| A user taps on the | button from any screen inside | |
| chat icon on any | of the buyers journey sub-task | |
| of the sub-task | screens | |
| screens in the | IF I am signed in to the app | |
| Journey flow | THEN a chat window will | |
| | open | |
| | AND I will be able to chat | |
| | with Reali | |
| | GIVEN that I am a user | |
| | WHEN I tap on the chat | |
| | button from any screen inside | |
| | of the buyers journey sub-task | |
| | screens | |
| | IF I am not a signed in to the | |
| | app | |
| | THEN I will be prompted to | |
| | sign in/sign up | |
| | AND I will not be able to chat | |
| | with Reali until I have signed | |
| | in or signed up | |
| 8. Call Button | GIVEN that I am a user | Zeplin action/call |
| A user taps on | WHEN I tap on the call button | Interaction |
| the call icon on | from any screen inside of the | CTA Destination |
| any of the sub- | buyers journey sub-task | Redirect-Call |
| task screens in | screens | Tapping on the |
| the Journey | THEN I expect to be able to | Call CTA will |
| flow | call Reali from my device | launch a call to |
| | GIVEN that I have tapped the | Reali from the |
| | call button | users device |
| | WHEN I see the in app alert | The user should |
| | AND I select Call | receive an app |
| | THEN a call will be initiated | alert confirming |
| | with Reali | that Reali wants |
| | GIVEN that I have tapped the | to call them |
| | call button | |
| | WHEN I see the in app alert | |
| | AND I select Cancel | |
| | THEN the alert will be closed | |
| | AND a call will not be | |
| | initiated with Reali | |
| 9. Sub-Task | GIVEN that I am an user | Zeplin tasks/status |
| Status Indicator | WHEN I complete a sub-task | Interaction: |
| Communicating | THEN I want to see that | For the MVP the only |
| the status of | reflected on the task overview | status options that are |
| journey sub- | screen | supported are not- |
| tasks to | | started or complete |
| our users | | Not started tasks will |
| | | have no indicator |
| | | Complete tasks will |
| | | have a green check |
| | | mark to indicate that |
| | | the status for |
| | | that task is complete |
| | | A user may have all |
| | | sub-status in non- |
| | | started status, a |
| | | combination of not- |
| | | started and completed |
| | | statuses, and all sub- |
| | | statuses in completed |
| | | status |
| 10. Sub-task | GIVEN that I am a user | Zeplin tasks/collapse |
| collapse | WHEN I scroll my screen up | |
| Collapsed view | while on the Tasks Overview | |
| of the sub- | screen | |
| tasks on the Task | THEN the image will collapse | |
| Overview screen | AND 1 will see header and the | |
| | sub-tasks for that section | |
| | BUT not the Image | |

### Tab Navigation:

To bring the end to end transaction for both Buyers and Sellers into the app, a bottom navigation bar may be provided, to allow users to easily explore and access the key parts of the app.
Using a bottom navigation bar may allow users access to the 5 top-level destinations within the app. Their location, visibility, and persistence allow quick access and pivoting between tabs. There may be 5 top-level destinations for Buyers and Sellers. The icons and order may remain the same between Buyers and Sellers, but content may change between the two. The tabs and their functions may be all or any subset of the following, shown in tables xiv and xv:

TABLE xiv
Tabs for Buyers

| Tab | |
|---|---|
| Name | Info |
| Journey | This is a task list view of the entire Buyer's journey from |
| | Discovery to Close. There are three main steps: Find a |
| | Home, Make an Offer, Win and Close. For each of |
| | the main steps, there are sub-steps that a user can work |
| | through. From the journey view, a user may be able to take |
| | actions (i.e. schedule appointments, get pre-approved) |
| | or link to other areas in the app (i.e. feed, profile). |
| Dash- | This is a quick access view to Appointments, Documents, |
| board | and the user's Team. This is collection of documents (i.e. |
| | comps) or appointments (i.e. visits) that have been |
| | requested elsewhere, either from the journey or a listing. |
| Listings | This main tab has three sub-tabs, Feed, Wishlist, and Offers. |
| | The feed is the listing results of a user's search/filters. The |
| | Wishlist tab is the homes a Buyer or co-Buyer have |
| | favorited. The offer tabs is a user's current and previous |
| | (if applicable) offers-details and status. |
| Profile | The profile tab is where a Buyer can edit their profile, |
| | preferences, add a co-Buyer, and switch to a Sell transaction. |
| Chat | The chat tab is where all people involved in the transaction |
| | can chat. This includes any Buyer, Co-Buyer, Sales Expert, |
| | Lead Expert and any additional Experts involved. All chat |
| | participants may have access to all chats and chat history. |

TABLE xv
tabs for Sellers

| | Tab | |
|---|---|---|
| Icon | Name | Info |
| | Journey | This is a task list view of the entire Seller's journey from preliminary CMAs |
| | | to Close. There are three main steps: Evaluate, Prepare, Sell. For each of the |
| | | main steps, there are sub-steps that a user can work through. From the |
| | | journey view, a user may be able to take actions (i.e. schedule appointments, |
| | | requests comps) or link to other areas in the app (i.e. listing, documents). |
| | Dashboard | This is a quick access view to Appointments, Documents, and the user's |
| | | Team. This is collection of documents (i.e. listing agreement) or |
| | | appointments (i.e. home inspections) that have been requested from the |
| | | journey. |
| | Listings | Before a listing is live, this is alive view of a user's listing being built. Once |
| | | the listing is live, this tab splits and has two sub-tabs: Activity and Offers. |
| | | The activity tab shows a user analytics on his listing (i.e. number of |
| | | disclosure requests, number of visitors during an open house). Once an offer |
| | | has been received, it may appear in the Offer tab. Here a user can review the |
| | | details of an offer, compare offers, and see offer revisions. |
| | Profile | The profile tab is where a Seller can edit their profile, preferences, add a co- |
| | | Seller, and switch to a Buy transaction. |
| | Chat | The chat tab is where all people involved in the transaction can chat. This |
| | | includes any Seller, Co-Seller, Sales Expert, Lead Expert and any additional |
| | | Experts involved. All chat participants may have access to all chats and chat |
| | | history. |

Many variations are possible depending inter alia on whether the platform is an iOS platform, Android platform or other, and on any other designer-specific considerations. For example, according to certain embodiments, all or any subset of the following main navigation tabs are provided for navigation: journey, dashboard, listings, buyer profile, chats. However, this is not intended to be limiting. According to certain embodiments, all or any subset of the following secondary navigation tabs are provided under the main Dashboard tab: Verification, Documents, Schedule, Team, and Offer. However, this is not intended to be limiting. According to certain embodiments, all or any subset of the following secondary navigation tabs are provided under the main Listings tab: My feed, Wishlist (aka Favorites), and My offer. However, this is not intended to be limiting. Also, any known process may be used to access chat, search and discovery for homes, etc. rather than, necessarily, the implementation described herein. Any flow may be used for the dashboard, verification, and offer functionality rather than, necessarily, the implementation described herein. Any suitable hierarchy of steps and substeps may be provided rather than, necessarily, the implementation described herein. Any suitable journey interaction, offer tracking etc. may be provided rather than, necessarily, the implementation described herein.

According to certain embodiments, when a user is prompted to make an offer, the user is prompted to activate a machine learning processor which generates, and display to a user, respective estimated probabilities of winning a home if certain prices are offered respectively. These probabilities may be estimated by storing and repeatedly e.g. continuously re-evaluating, which price offers, typically relative to estimated home value, succeeded in obtaining buyer acceptance of the offer. Any suitable independent variables may be employed, such as a score given to the market at the time of the offer.

It is appreciated that terminology such as “mandatory”, “required”, “need” and “must” refer to implementation choices made within the context of a particular implementation or application described herewithin for clarity and are not intended to be limiting since in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may cam/computer-readable instructions for performing any or all of the operations of any of the methods shown and described herein, in any suitable order including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein may be deployed in a cloud environment. Clients e.g. mobile communication devices such as smartphones may be operatively associated with but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false and to perform y each time x is determined to be true, thereby to yield a processor which performs y at least once, typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous, given the state or condition or data, and/or may prevent at least one outcome which is disadvantageous given the state or condition or data. Alternatively or in addition, an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly, although not limited to, those described in the Background section or in publications mentioned therein.

Conversely, features of the invention, including operations, which are described for brevity in the context of a single embodiment or in a certain order, may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

Any suitable communication may be employed between separate units herein e.g. wired data communication and/or in short-range radio communication with sensors such as cameras e.g. via WiFi, Bluetooth or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

1. A software system comprising:
a mobile app having a backend including a processor, whose logic supports plural functionalities used by end-users/clients of the mobile app;
logic presenting, to each of a population of end users of the mobile app, a linear list of said functionalities, thereby defining an ordering of said functionalities;
logic presenting an indication (aka journey status change aka journey status update), to each individual end-user, in at least near-real time, of how far along said list s/he has progressed in using said functionalities,
wherein the mobile app logic allows at least one individual end user to use said functionalities repeatedly and in a sequence other than defined by said ordering, at least once said individual end-user has used all of said functionalities at least once.

2. A system according to claim 1 wherein the backend provides at least one p2p (peer to peer notification, including a journey status change of an end-user, to a p2p processor aka p2p subsystem aka p2p logic which gets messages indicating journey status changes, and stores them.

3. A system according to claim 2 wherein said p2p subsystem comprises a pubnub server which gets pubnub messages indicating journey status changes, and stores them.

4. A system according to claim 2 wherein said indication comprises a graphic indication e.g. checkmark associated with each of said functionalities on said linear list, which the individual end-user has already used and wherein no graphic indication is associated with functionalities on said linear list, which the individual end-user has not yet used.

5. A system according to claim 2 wherein said p2p notification includes a journey data flat map storing a user journey steps and/or tasks, and wherein at least one client uses a journey payload to update at least one journey task on each p2p notification.

6. A system according to claim 1 wherein when a client receives a journey status update, the update may be represented in a flat (not relational) map which includes a representation of the user journey including, in a single list, steps and/or tasks included in said journey, and wherein the update also includes a step/task key and/or a display name.

7. A system according to claim 2 wherein a single p2p channel and infrastructure is used to pass, as p2p messages,
chat messages including text for the end-user to view; and
journey status update.

8. A system according to claim 7 wherein at least one chat message includes metadata which includes an identification of the chat message's sender and/or a media download key and/or a timestamp.

9. A system according to claim 2 wherein the p2p processor uses sockets rather than API polling to receive a real time indication of journey status changes.

10. A system according to claim 8 wherein said metadata is stored in the p2p side, in association with messages history.

11. A system according to claim 8 wherein said metadata is stored locally, on the end user's smartphone's local storage.

12. A system according to claim 1 wherein at least one mobile client saves at least some properties in order to subsequently display said properties later including retrieving said properties from the local storage rather than requesting said properties from the p2p service.

13. A system according to claim 2 and also comprising at least one ‘get history’ API via which chat and status update messages stored by said p2p subsystem are retrieved.

14. A system according to claim 7 wherein a server, upon identifying a journey status change relating to a given end-user, sends a message to a dedicated p2p channel extending to that end-user's client and wherein the end-user's client asks the history of said dedicated channel at a subsequent time,
and if the client identifies a status change type message, the client makes a journey status change.

15. A system according to claim 14 wherein the client includes logic which prioritizes asking the history during client-idle time over asking the history at a time t which is not client-idle time.

16. A system according to claim 14 wherein the client includes logic which prioritizes asking the history during channel-idle time over asking the history at a time t which is not channel-idle time.

17. A system according to claim 15 wherein the client includes logic which always asks the history during idle time.

18. A method for facilitating use of a mobile app by end-users, the method comprising:
providing a mobile app having a backend including a processor, whose logic supports plural functionalities used by end-users/clients of the mobile app;
presenting, to each of a population of end users of the mobile app, a linear list of said functionalities, thereby defining an ordering of said functionalities;
presenting an indication (aka journey status change aka journey status update), to each individual end-user, in at least near-real time, of how far along said list s/he has progressed in using said functionalities,
wherein the mobile app logic allows at least one individual end user to use said functionalities repeatedly and in a sequence other than defined by said ordering, at least once said individual end-user has used all of said functionalities at least once.

19. A method according to claim 18 wherein the end-users include buyer end-users and seller end-users and the mobile app supports creation and managing by an individual buyer end-user, of plural draft offers to plural seller end-users wherein said managing comprises defining branching logic for sending said draft offers to said seller end-users thereby to enable a buyer interested in more than one property offered by more than one respective seller end-user, to create a main offer and at least one additional draft offer/s and to define, even before the main offer has been accepted or refused, an actionable backup plan defining, via said branching logic, how said additional draft offers are to be engaged if the main offer is refused.

20. A method according to claim 18 wherein the end-users include buyer end-users and seller end-users and the mobile app supports creation and managing by an individual buyer end-user, of at least one draft offer to at least one respective seller end-user and wherein said managing includes modifying at least one parameter of a draft offer, responsive to a counter-offer proposed by said seller end-user.

21. A method according to claim 18 wherein the end-users include buyer end-users and seller end-users and the mobile app supports creation and managing by an individual buyer end-user, of at least one offer to at least one respective seller end-user and wherein a virtual assistant is used to generate said offer.

22. A method according to claim 21 wherein said offer includes a proposed buyer-seller transaction whose value is generated automatically, thereby to allow buyer end-users to benefit from automatically generated real estate value predictions.

23. A method according to claim 21 wherein at least one market report is retrieved during creation of at least one offer.

24. A method according to claim 21 wherein creation of at least one offer is expedited by holding a chat between the buyer end-user of said app and an expert end-user of said app.

25. A computer program product, comprising a non-transitory tangible computer readable medium having computer readable program code embodied therein, said computer readable program code adapted to be executed to implement a method for facilitating use of a mobile app by end-users, the method comprising:
providing a mobile app having a backend including a processor, whose logic supports plural functionalities used by end-users/clients of the mobile app;
presenting, to each of a population of end users of the mobile app, a linear list of said functionalities, thereby defining an ordering of said functionalities;
presenting an indication (aka journey status change aka journey status update), to each individual end-user, in at least near-real time, of how far along said list s/he has progressed in using said functionalities,
wherein the mobile app logic allows at least one individual end user to use said functionalities repeatedly and in a sequence other than defined by said ordering, at least once said individual end-user has used all of said functionalities at least once.

26. A system according to claim 16 wherein the client includes logic which always asks the history during idle time.
